(19) United States
(12) Patent Application Publication
(10) Pub. No.: US 2012/0307811 A1
(43) Pub. Date: Dec. 6, 2012

(54) APPARATUS AND METHOD FOR ESTABLISHING UPLINK SYNCHRONIZATION IN A WIRELESS COMMUNICATION SYSTEM

(75) Inventors: Kibum Kwon, Seoul (KR); Myungcheul Jung, Seoul (KR)

(73) Assignee: PANTECH CO., LTD., Seoul (KR)

(21) Appl. No.: 13/578,566

(22) PCT Filed: Feb. 11, 2011
(86) PCT No.: PCT/KR11/00959

§ 371 Date: Aug. 10, 2012

(30) Foreign Application Priority Data
Feb. 12, 2010 (KR) 10-2010-0013430

(51) Int. Cl. H04W 56/00

(52) U.S. Cl. 370/336

(57) ABSTRACT

A method for establishing uplink synchronization in a base station, according to one embodiment of the present description, comprises performing a process for connection to user equipment, setting component carrier aggregation information, generating uplink timing groups from the set component carrier aggregation, and transmitting, via a plurality of component carriers, information on the thus-generated uplink timing groups simultaneously to the user equipment.

### CROSS-REFERENCE TO RELATED APPLICATIONS

This application is the National Stage Entry of International Application PCT/KR2011/000959, filed on Feb. 11, 2011, and claims priority from and the benefit of Korean Patent Application No. 10-2010-0013430, filed on Feb. 12, 2010, both of which are incorporated herein by reference for all purposes as if fully set forth herein.

### BACKGROUND

1. Field

The present invention relates to a method and apparatus for establishing an uplink (UL) synchronization in a wireless communication system, and more particularly, is to a method and apparatus for establishing an uplink (UL) synchronization with respect to at least one component carrier (CC).

2. Discussion of the Background

Synchronization between a user equipment (UE) and an evolved node B (eNB) is an important issue in a wireless communication system since exchange of information between the UE and the eNB may be abnormally performed without synchronization.

Unlike a conventional wireless communication system that supports a single component carrier (CC) or a single service band, a current wireless communication system attempts to satisfy a user demand through use of a plurality of CCs. However, a detailed scheme for providing synchronization information associated with the plurality of CCs has not been provided yet.

Synchronization is a factor that has a great effect on an efficiency of a network. Accordingly, there is a desire for a method for effective synchronization in a wireless communication including a plurality of CCs.

### SUMMARY

Therefore, the present invention has been made in view of the above-mentioned problems, and an aspect of the present invention is to provide a method and apparatus for effectively establishing an uplink (UL) synchronization in a component carrier (CC) aggregation environment in a wireless communication environment that operates a plurality of CCs since efficiency of a synchronization process is directly associated with efficiency of a network, and secures stability of transmission.

Another aspect of the present invention is to provide a method and apparatus for simultaneously establishing synchronization in a wireless communication system.

Another aspect of the present invention is to provide a method and apparatus for transceiving synchronization information to be used for establishing synchronization in a wireless communication system.

Another aspect of the present invention is to provide a method and apparatus for configuring a synchronization group with respect to a plurality of CCs in a wireless communication system.

Another aspect of the present invention is to provide a method and apparatus for configuring a synchronization group with respect to a plurality of CCs based on a connection mode of a UE in a wireless communication system.

Another aspect of the present invention is to provide a method and apparatus for configuring a synchronization group based on characteristics of a plurality of CCs available in a wireless communication system.

Another aspect of the present invention is to provide a method and a UE that may configure a UL timing synchronization group with respect to a plurality of CCs in a wireless communication system.

Another aspect of the present invention is to provide a method and a UE that may obtain synchronization information associated with a plurality of CCs through a random access procedure in a wireless communication system, and may establish and update synchronization with an eNB.

In accordance with an aspect of the present invention, there is provided a is method for an evolved Node-B (eNB) to establish an uplink (UL) synchronization in a wireless communication system, the method including: simultaneously receiving a synchronization request message from a user equipment (UE) through component carriers (CCs) forming a CC set; simultaneously transmitting UL synchronization information to the UE through a few or all of the CCs forming the CC set; simultaneously receiving the synchronization message from the UE through one or more delegate CCs of a UL timing group; and simultaneously transmitting UL synchronization information corresponding to the UL timing group to the UE through the one or more delegate CCs, and the delegate CCs are selected by the UE or the eNB, based on a state of the UL timing group and characteristics of a plurality of CCs forming the UL timing group.

In accordance with another aspect of the present invention, there is provided a method for a UE to establish a UL synchronization, the method including: simultaneously transmitting a synchronization request message to an eNB through CCs forming a CC set; simultaneously receiving UL synchronization information from the eNB through a few or all of the CCs forming the CC set; simultaneously transmitting the synchronization request message to the eNB through one or more delegate CCs of a UL timing group; simultaneously receiving UL synchronization information corresponding to the UL timing group from the eNB through the one or more delegate CCs; and establishing synchronization by applying, to the UL timing group, the UL synchronization information corresponding to the UL timing group received through the one or more delegate CCs, and the delegate CCs are selected by the UE or the eNB based on a state of the UL timing group and characteristics of a plurality of CCs forming the UL timing group.

In accordance with another aspect of the present invention, there is provided an eNB that establishes a UL synchronization in a wireless communication system, the eNB including: a UL synchronization establishing unit to generate UL synchronization information corresponding to a UL timing group; and a transceiving unit to simultaneously receive a synchronization request message from a UE through one or more delegate CCs of the UL timing group, and to simultaneously transmit the UL synchronization information corresponding to the UL timing group to the UE through the one or more delegate CCs, and the delegate CCs are selected by the UE or the eNB based on a state of the UL timing group and characteristics of a plurality of CCs forming the UL timing group; and before the UL group is generated or when the UL group requires reconfiguration, the transceiving unit simultaneously receives a synchronization request message from the UE through CCs forming a CC set, and simultaneously transmits UL synchronization information to the UE through a few or all of the CCs forming the CC set.

In accordance with another aspect of the present invention, there is provided a UE that establishes a UL synchronization in a wireless communication system, the UE including: a transceiving unit to simultaneously transmit a synchronization request message through one or more delegate CCs of a UL timing group, and to simultaneously receive UL synchronization information corresponding to the UL timing group from an eNB through the one or more delegate CCs; and a UL timing adjusting unit to establish synchronization by applying, to the UL timing group, the UL synchronization information corresponding to the UL timing group received through the one or more CCs, and the delegate CCs are selected by the UE or the eNB is based on a state of the UL timing group and characteristics of a plurality of CCs forming the UL timing group, and before the UL group is generated or when the UL group requires reconfiguration, the transceiving unit simultaneously transmits a synchronization request message to the eNB through CCs forming the CC set, and simultaneously receives UL synchronization information from the eNB through a few or all of the CCs forming the CC set.

### BRIEF DESCRIPTION OF THE DRAWINGS

FIG. 1 is a diagram illustrating an example of a system that uses a plurality of component carriers (CCs) according to an embodiment of the present invention;

FIG. 2 is a diagram illustrating an example associated with a timing advance (TA) in a synchronization process according to an embodiment of the present invention;

FIG. 3 is a diagram illustrating a random access process performed between a user equipment (UE) and an evolved Node-B (eNB) according to an embodiment of the present invention;

FIG. 4 is a diagram illustrating a process that obtains an uplink (UL) synchronization according to an embodiment of the present invention;

FIG. 5 is a diagram illustrating a process that obtains a UL synchronization according to another embodiment of the present invention;

FIG. 6 is a diagram illustrating a process that obtains a UL synchronization according to an embodiment of the present invention;

FIG. 7 is a diagram illustrating a process that obtains a UL synchronization according to another embodiment of the present invention;

FIG. 8 is a diagram illustrating an eNB that enables a UE to obtain a UL synchronization according to an embodiment of the present invention;

FIG. 9 is a diagram illustrating a UE that obtains a UL synchronization according to an embodiment;

FIG. 10 is a diagram illustrating a configuration of an eNB according to an embodiment of the present invention; and

FIG. 11 is a diagram illustrating a configuration of a receiving apparatus according to an embodiment of the present invention.

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

The specifications will describe a wireless communication system as an example, and operations performed in wireless communication may include all operations performed in a system that manages the wireless communication and a wireless communication device that transmits data.

The wireless communication system may provide various communication services such as voice data, packet data, and the like.

The wireless communication system may include a user equipment (UE) and an evolved Node-B (eNB).

The UE may be an inclusive concept indicating a user terminal utilized in a wireless communication, including a UE in wideband code division multiple access (WCDMA), Long Term Evolution (LTE), High Speed Packet Access (HSPA), and the like, and a mobile station (MS), a user terminal (UT), a subscriber station (SS), a wireless device and the like in Global System for Mobile Communications (GSM).

The eNB or a cell may refer to a fixed station where communication with the UE is performed, and may also be referred to as a Node-B, a base transceiver system (BTS), an access point, and the like.

The eNB or the cell may be construed as an inclusive concept indicating a portion of an area covered by a radio network controller (RNC) in WCDMA, and the like, and the concept may include various cell coverage areas, such as a megacell, macrocell, a microcell, a picocell, a femtocell, and the like.

In the specifications, the UE and the eNB are used as two inclusive transceiving subjects to embody the technology and technical concepts described in the specifications, and may not be limited to a predetermined term or word.

A multiple access scheme applied to the wireless communication system may not be limited. The wireless communication system may utilize varied multiple access schemes, such as Code Division Multiple Access (CDMA), Time Division Multiple Access (TDMA), Frequency Division Multiple Access (FDMA), Orthogonal is Frequency Division Multiple Access (OFDMA), Orthogonal Frequency Division Multiple Frequency Division Multiple Access (OFDM-FDMA), Orthogonal Frequency Division Multiple Time Division Multiple Access (OFDM-TDMA), Orthogonal Frequency Division Multiple Code Division Multiple Access (OFDM-CDMA), and the like.

Uplink (UL) transmission and downlink (DL) transmission may be performed based on a time division duplex (TDD) scheme that performs transmission based on different times, or based on a frequency division duplex (FDD) scheme that performs transmission based on different frequencies.

An embodiment of the present invention may be applicable to resource allocation in an asynchronous wireless communication scheme that is advanced through GSM, WCDMA, and HSPA, to be LTE and LTE-advanced, and may be applicable to resource allocation in a synchronous wireless communication scheme that is advanced through CDMA and CDMA-2000, to be Ultra Mobile Broadband (UMB). Embodiments of the present invention may not be limited to a specific wireless communication scheme, and may be applicable to all technical fields to which a technical idea of the present invention is applicable.

Throughout the specifications, a component carrier may be denoted by a CC and may be distinguished by names, for example, CC0, CC1, and the like. However, a number included in a name of each CC may not always match an order of a corresponding CC or a location of a frequency band of the corresponding CC.

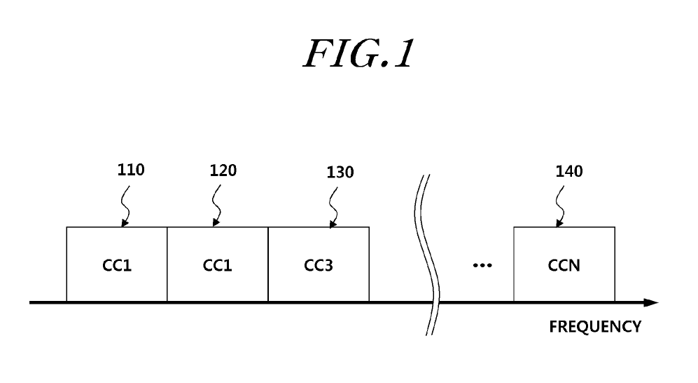

FIG. 1 illustrates an example of a wireless communication system that uses a plurality of CCs according to an embodiment of the present invention.

Referring to FIG. 1, the wireless communication system may be a next generation communication system, including an LTE system and an LTE-A system.

The LTE/LTE-A system may extend a bandwidth to satisfy a high data transmission rate corresponding to a system requirement, and may use a plurality of CCs which are unit carriers. Here, a single CC may have a maximum bandwidth of 20 megahertz (MHz). Resource allocation may be performed within a bandwidth of 20 MHz depending on a service. However, it is merely an example during a process of embodying a system. Depending on a configuration of a system, a single CC may be configured to have a bandwidth greater than or equal to 20 MHZ. Also, a plurality of CCs may be bound and used as a single system band, and may be referred to as a carrier aggregation (CA).

As illustrated in FIG. 1, when five CCs having a maximum bandwidth of 20 MHz are used, a bandwidth may be expanded up to 100 MHz to support a quality of service. In this example, an allocable frequency band, which may be determined by each CC, may be contiguous or non-contiguous based on a scheduling of the CA.

Throughout the specifications, a component carrier may be denoted by a CC and may be distinguished by names, for example, CC0, CC1, and the like. However, a number included in a name of each CC may not always match an order of a corresponding CC or a location of a frequency band of the corresponding CC.

Referring to FIG. 1, the CA may be configured to include a first CC (CC1) 110, a second CC (CC2) 120, a third CC (CC3) 130, and an N^{th} CC (CCN) 140. A UL and a DL allocated to each CC may be different from each other, or may be the same as one another based on a scheduler. The CC may be a single CC. Throughout the specification, one or more CCs may be included in a single group. That is, the one or more CCs included in the group may indicate that the one or more CCs configure a single group. Also, a group including a single CC may exist.

In a wireless communication environment, an electric wave may experience a propagation delay while the electric wave is transferred from a transmitter to a receiver. Accordingly, although both the transmitter and the receiver are accurately aware of a time when the electric wave is transmitted from the transmitter, a time when the electric wave is received by the receiver may be affected by a distance between the transmitter and the receiver, an ambient propagation environment, and the like, and may vary over time when the receiver moves. When the receiver is not accurately aware of a point in time when a signal transmitted from the transmitter is to be received, the receiver may fail to receive the signal, or may receive a signal distorted due to the propagation delay and may fail to perform communication.

Accordingly, in the wireless communication system, synchronization between the eNB and the UE may be established first to receive a signal, irrespective of a UL and a DL. That is, a synchronization process is an essentially important process in a communication system, and maintaining the synchronization process may also significantly affect a stability of the system and a quality of communication.

There may be various types of synchronization, such as a frame synchronization, an information symbol synchronization, a sampling period synchronization, and the like. The sampling period synchronization may need to be obtained basically, so as to distinguish a physical signal.

In DL transmission corresponding to a communication link of is transmission in a direction from the eNB to the UE, synchronization may be obtained in the UE based on a signal of the eNB. The eNB may transmit a predetermined signal that is mutually prearranged, so that the UE may readily obtain a DL synchronization, and the UE may need to accurately distinguish a time when the predetermined signal is transmitted from the eNB. In a case of a DL, a single eNB may simultaneously transmit the same synchronization signal to a plurality of UEs and thus, each UE may independently obtain synchronization based on the synchronization signal.

Conversely, in a case of a UL, the eNB may receive signals transmitted from the plurality of UEs and thus, the eNB may have difficulty in obtaining synchronization based on one of the UEs. Accordingly, a synchronization process that is different from the DL may be required.

When distances between the UEs and the eNB are different from each other, the UEs may have different transmission delay times. When each UE transmits UL information based on a corresponding DL synchronization, information transmitted from each UE may be received by the eNB at different times.

Although the uplink information transmitted from each UE is received at different times, the information may be received with a complexity being increased when a transmission scheme adopted by the wireless communication system, such as CDMA, is capable of separately receiving the information. However, in a wireless communication system that is based on OFDMA or FDMA, uplink transmission information of all the UEs may be simultaneously received by the eNB and may be demodulated and thus, a reception performance may increase as the uplink transmission information is received at an accurate time, and a reception performance may be rapidly deteriorated as a reception is time difference of each UE signal received in the eNB is increased.

Accordingly, in a wireless communication system that utilizes OFDMA or SC-FDMA as a UL transmission scheme, such as LTE, a timing alignment value may be calculated for each UE based on a random access scheme and the like, to obtain a transmission delay time in a DL and a transmission delay time in a UL, and each UE may be informed of the calculated TA value, so that a UL synchronization is obtained.

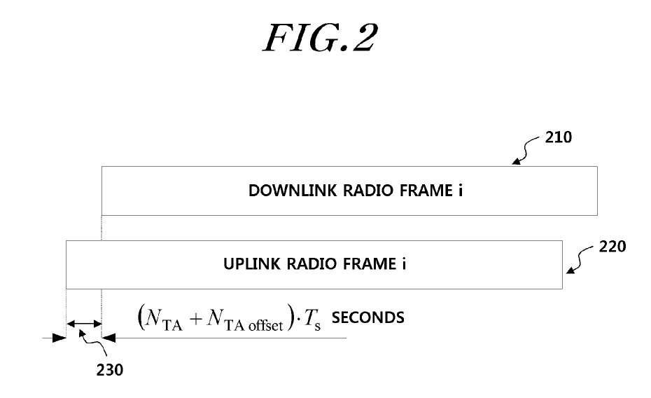

FIG. 2 illustrates an example associated with a timing advance (TA) in a synchronization process according to an embodiment of the present invention.

In general, a UL radio frame i 220 may need to be transmitted at the same point in time as a point in time when a DL radio frame i 210 is transmitted, so as to perform communication between an eNB and a UE. However, a time difference may exist between the UE and the eNB due to propagation delay and the like.

Accordingly, a TA 230 may be applied to enable the UE to transmit the UL radio frame i 220 a little earlier than the DL frame i 210 by taking the propagation delay into consideration, so that synchronization between the eNB and the UE may be obtained. An equation to calculate the TA may be expressed by Equation 1.

TA=(N_{TA}+N_{TA offset})·Tₛ seconds [Equation 1]

Here, N_{TA} denotes a variable value controlled based on TA command information transmitted from the eNB, and N_{TAoffset} denotes a fixed value set based on a frame structure. Tₛ denotes a period of sampling. As shown in FIG. 2, to obtain a UL synchronization, the UE may receive the TA command information provided by the eNB, and may proceed with a TA based on the received TA command information. Accordingly, synchronization for wireless communication with the eNB may be obtained.

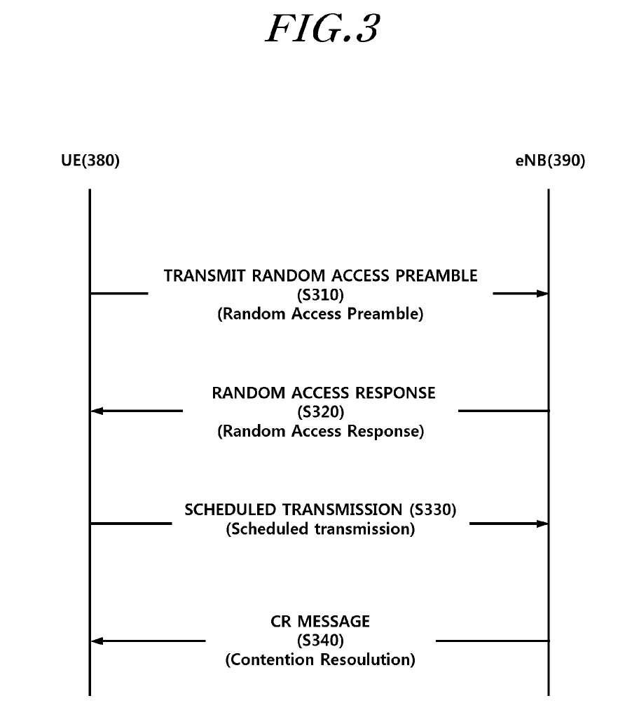

FIG. 3 illustrates a random access process performed between a UE and an eNB according to an embodiment of the present invention.

To perform transmission and reception of data with an eNB 390, a UE 380 may need to obtain a UL synchronization. To obtain the UL synchronization, the UE 380 may proceed with a process of receiving information required for synchronization, from the eNB 390. FIG. 3 shows a random access procedure for receiving information required for synchronization. The random access procedure may be applicable when a UE is newly coupled to a network through a handover and the like. Also, upon completing the coupling, the UE may proceed with the random access procedure even under a circumstance such as synchronization, a state change, for example, from an RRC_IDLE to an RRC_CONNECTED, and the like.

The UE 380 may randomly select a preamble signature so as to generate a random access preamble. Subsequently, the UE 380 may transmit the selected preamble to the eNB 390 (step S310). The process of selecting the preamble signature may be contention-based selection or contention-free selection. In this example, the eNB may inform the UE of a previously reserved random access preamble, and the UE may transmit, to the eNB 390, a preamble selected based on received information (step S310). Also, according to the contention-free selection, a procedure associated with a contention resolution (CR) message, which is required in the contention-based selection, may not need to be performed.

Here, the UE 380 may recognize random access-radio network temporary identifier (RA-RNTI) based on a transmission time and a frequency resource temporarily is selected for selecting a preamble or for random access channel (RACH) transmission.

The eNB 390 may perform random access response (RAR) with respect to the preamble received from the UE 380. In this example, the eNB 390 may transmit an RAR message through a physical downlink shared channel (PDSCH).

Information transmitted through the RAR message may include, for example, identification information of the UE preamble received by the eNB, an identifier (ID) of the eNB, a cell radio network temporary identifier (C-RNTI), information associated with a time slot where the preamble is received, TA information, and the like. Timing information for a UL synchronization may be received through the RAR message and thus, the UE 380 may perform the UL synchronization with the eNB 390. The UE 380 may perform a scheduled transmission that transmits data at a scheduled time determined based on the TA information received in step S320 (step S330). In this example, the UE 380 may transmit synchronized data through a physical uplink shared channel (PUSCH), and may perform hybrid automatic repeat request (HARQ).

Examples of a message transmitted in step S330 may include a radio resource control (RRC) connection request, a tracking area update, a scheduling request, and the like. Also, one of the messages may include a temporary C-RNTI, a C-RNTI (if the UE already has one), UE identification information, and the like.

In steps S310 through 330, collision may occur and thus, when the eNB 390 transmits a CR message (step S340), the UE 380 may i) determine whether a received message corresponds to the UE 380, and may transmit an acknowledgement (ACK) when the received message corresponds to the UE 380 or ii) may not transmit is response data when the received message corresponds to another UE. Also, the UE 380 may not transmit the response data when the UE 380 misses DL allocation or fails to decode the message. Also, the CR message may include a C-RNIT, UE identification information, and the like.

Unlike a process of obtaining a TA when a single carrier is utilized, in a wireless system that uses a plurality of CCs, TA values of the CCs may have a high probability of being different from each other when locations of center frequencies of the CCs are significantly distant from each other as shown in FIG. 1, when the CCs are supported by different devices in a network, or the like.

Accordingly, when a synchronization obtaining scheme used for a single carrier is applied as is, the CCs may have difficulty in obtaining the UL synchronization for the CCs. Accordingly, the UE may perform stable UL communication for a few CCs that obtain UL synchronization from among available CCs.

When the UE transmits, based on the same UL synchronization reference, information through CCs of which UL synchronization references are different from each other, a probability of transmission error may be significantly high, and a time and resources for restoring the error may be wasted. In this example, it is difficult to satisfy a UL quality of service (QoS) for an application program required by a system.

When the wireless communication uses a plurality of CCs, a transmission delay time may be different in a DL based on a supporting scheme in a radio network and a characteristic of each CC with respect to a single UE. Accordingly, when CCs or CCs having the same TA value are configured as a set, a UL synchronization reference may be different for each CC set and thus, UL performance may be deteriorated.

Therefore, according to embodiments of the present invention, in a wireless communication system that uses a plurality of CCs, a method in which the UE obtains a UL synchronization of a corresponding CC or a group of CCs based on a type of each CC, a location of a center frequency, a network service type, and the like when CCs or groups including at least one CC have different UL synchronization references.

Therefore, according to embodiments of the present invention, in the wireless communication system that uses a plurality of CCs, a method in which the UE obtains a UL synchronization of a corresponding CC or a group of CCs based on a type of each CC, a location of a center frequency, a network service type, and the like when CCs or groups including at least one CC have different UL synchronization references. Detailed processes will be described as follows. Hereinafter, the UE may be referred to as a UE and the eNB may be referred to as an eNB.

In the specifications, simultaneously transmitting or receiving a signal through a plurality of CCs may include transmitting and receiving a signal through the plurality of CCs in parallel. Simultaneousness may indicate that the eNB or the UE may simultaneously perform transmission/reception through the plurality of CCs, the transmission/reception has a temporal coincidence, and a unit of transmission/reception is simultaneously performed, and processed in parallel. In this example, a slight temporal difference may exist.

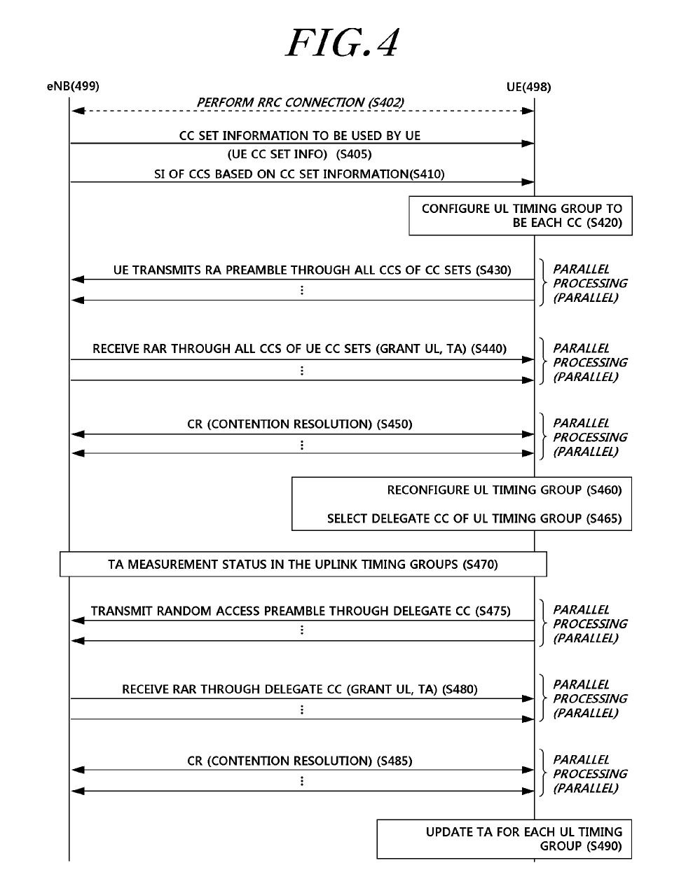

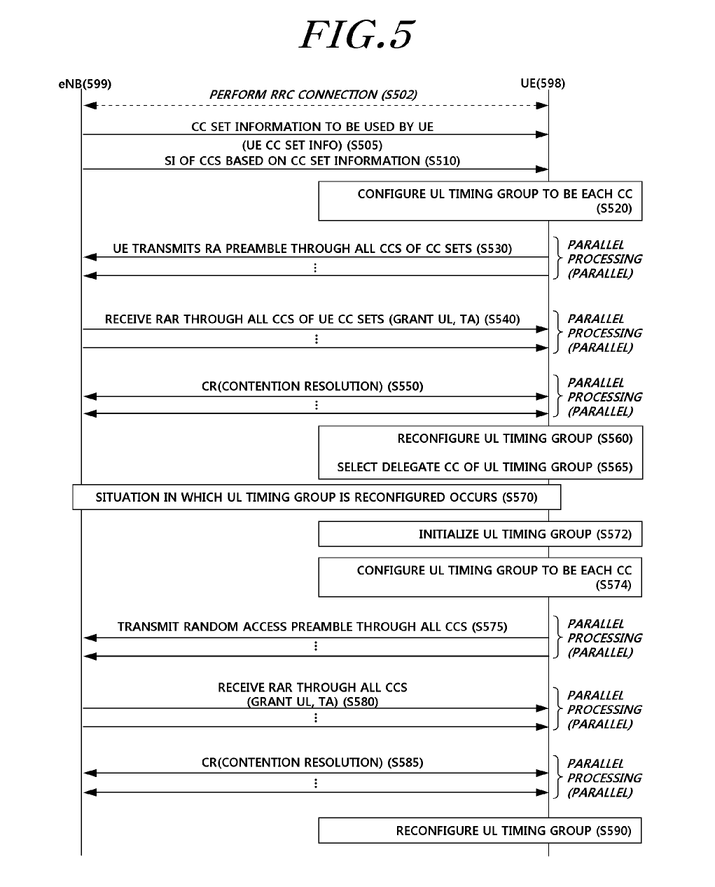

FIGS. 4 and 5 illustrate a process of obtaining a UL synchronization, and show that a UE may configure a group associated with a timing for each CC and perform random access procedure (RAP) through a delegate CC of each timing group when an eNB transmits information associated with a plurality of CCs.

FIG. 4 illustrates a process that obtains a UL synchronization according to an embodiment of the present invention.

Referring to FIG. 4, when an RRC connection mode is an RRC_CONNECTED mode indicating that a UE 498 and an eNB 499 are connected, step S405 may be performed. When the RRC connection mode is an IDLE mode or requires resetting, step S402 may be performed first, and then step S410 is performed.

In step S402, RRC connection may be performed. When the RRC connection mode is the IDLE mode or requires resetting, the eNB 499 may not be able to define a CC set of the corresponding UE and may not transmit CC set information. Therefore, the CC set information may be formed by selecting at least one CC to perform RRC connection so that the RRC connection is performed (step S402).

At least one CC to perform the RRC connection may be selected based on one of the following methods.

i) select a CC that is most appropriate for attempting RRC connection based on information measured by the UE 498

ii) attempt RRC connection based on information fixedly set in a system and stored in an internal memory of the UE 498

iii) attempt RRC connection based on information transmitted to the UE 498 from the eNB 499 through system information

iv) attempt RRC connection through CCs corresponding to system information of the available CCs stored in an internal memory of the UE 498

For example, a UE in an IDLE mode may select a single DL CC for the RRC connection based on the conditions, and may receive system information via a is broadcasting channel that is transmitted through the selected CC. Based on the received system information, the selected DL CC and a UL CC having a linkage with the DL CC may be configured as a primary serving cell (PCell). The UE may transmit, to an eNB, an RRC connection request message through the PCell. In this example, the UE may transfer the RRC connection request message to the eNB through an RACH procedure.

Here, the DL CC corresponding to the PCell may be referred to as a DL primary CC (DL PCC), and the UL CC corresponding to the PCell may be referred to as a UL primary CC (UL PCC). Also, a CC corresponding to a secondary serving cell (SCell) 920 in a DL may be referred to as a DL secondary CC (DL SCC), and a CC corresponding to the SCell in a UL may be referred to as a UL secondary CC (UL SCC).

The PCell and the SCell have characteristics as follows.

First, the PCell may be used for PUCCH transmission.

Second, the PCell is always activated, whereas the SCell 920 is activated or deactivated based on a predetermined condition.

Third, when the PCell experiences radio link failure (RLF), RRC reconnection may be triggered. When the SCell 920 experiences RLF, RRC reconnection may not be triggered.

Fourth, the PCell may be changed by a change of a security key or by a handover procedure accompanying the RACH procedure. In a case of an MSG4 (contention resolution), only a PDCCH that indicates the MSG4 may be transmitted through the PCell, and MSG4 information may be transmitted through the PCell or the SCell.

Fifth, non-access stratum (NAS) information may be received through the PCell.

Sixth, the PCell may be configured as a pair of a DL PCC and a UL PCC.

Seventh, each UE sets a different CC as the PCell.

Eighth, a procedure such as, reconfiguration, adding, and removal of the SCell may be performed by an RRC layer. To add a new SCell, RRC signaling may be used to transmit system information associated with a dedicated SCell.

Technical concept of the PCell and the SCell in embodiments of the present invention may not be limited to the descriptions provided in the foregoing, and may include further examples.

When RRC connection setup is completed through one of the methods, and the RRC connection mode between the eNB 499 and the UE is the RRC_CONNECTED mode, step S405 may be performed.

The eNB 499 may allow the UE 498 to use a plurality of CCs based on a performance of hardware of the UE 498, available frequency resources of the eNB 499, and the like, and may define the plurality of CCs to be a CC set. The eNB 499 may transmit, to the UE 498, CC set information associated with the CC set that is allowed to the UE 498 (step S405). The CC set information may include CC IDs corresponding to the CCs included in the CC set, index information indicating each CC, offset information indicating another CC based on at least one CC, and the like. The CC set information may further include set ID information to distinguish each CC set formed of at least one CC.

The UE 498 may receive the CC set information determined based on the above condition, from the eNB 499 (step S405). According to a scheme of transmitting and receiving the CC set information, the eNB 499 may include the CC set information in an RRC reconfiguration message for transmission to the UE 498, or may use another message for transmission. Also, the CC set information may be configured by adding/removing each CC.

For example, when initial CC set information is transmitted, the CC set information configured of DL CC1, DL CC2, and DL CCN may be configured as an added DL CC list and the list may include CC1, CC2, and CCN. In the same manner, UL CC set information may be configured as an added UL CC list. As another example, when the CC set information is changed, that is, when the configured DL CC set is changed into CC1, CC3, and CCN, the DL CC set information may be transmitted by configuring CC2 as a removed DL CC list and CC3 as an added DL CC list.

The UE 498 may receive system information (SI) associated with CCs in the CC set, based on the received CC set information (step S410). The SI may include center frequency information of each CC, information associated with a total frequency band of a corresponding CC, and the like.

When a CC that is incapable of transmitting SI exists from among the CCs in the CC set, for example, an extension CC (ECC), or a CC that is incapable of receiving SI transmitted via a broadcasting channel (for example, a DL CC that belongs to an SCell) exists, SI of the ECC may be received by a CC that is capable of receiving the SI or may be transformed in a form of control information of the CC that is capable of receiving the SI and may be received by the CC.

The transformed SI may be transmitted to the UE together with the CC set information included in the RRC reconfiguration message transmitted by the eNB, or is may be transmitted to the UE through the RRC reconfiguration message after the CC set information is received. Also, the current stage may be performed without receiving the SI associated with the ECC.

The UE 498 may configure a UL timing group based on the received CC set information and the SI information, and each UL timing group may be configured to include a single CC (step S420). A single CC is configured to be a single group so as to increase a number of opportunities for UL synchronization of the UE 498 and to secure prompt obtaining of the UL synchronization. Also, a UL timing group for each CC may be newly configured based on TA information to be received.

That is, step S420 corresponds to a process of initializing a UL timing group. For example, when CC set information of a CC set including three CCs, that is, CC1, CC2, and CC3 is received in step S405, and SI associated with the three CCs, that is, CC1, CC2, and CC3 is received in step S410, a first group including only CC1, a second group including only CC2, and a third group including only CC3 may be configured to be the UL timing group.

As described in the foregoing, the UL timing group may be configured by including a plurality of CCs into a single group, and CCs included in the UL timing group may be synchronized at the same time of a synchronization process or may be to synchronized in the same manner as the synchronization process. For example, a case of applying the same TA value determined in the corresponding UL timing group to transmission may be included.

The UE 498 may select and set a predetermined random access preamble from among a plurality of preamble sets so as to obtain a UL timing, and may transmit, to is the eNB 499, a preamble signal selected based on resource information defined in SI of each CC, through each UL CC of the UL timing group (step S430). The preamble may be included in a synchronization request message through which a UE requests synchronization.

According to the method of transmitting the signal, transmission may be simultaneously performed by the UE 498 through use of time/frequency resources set by the eNB 499. Simultaneous transmission may indicate that a preamble is transmitted through two or more CCs in parallel. In this example, the selected preamble may be transmitted through a corresponding CC of each UL timing group in parallel. Accordingly, preamble transmission in step S430 may indicate that N transmissions are simultaneously performed through N CCs.

A method of setting a linkage between a DL CC and a UL CC, which is a reference for measuring a TA value with respect to a single UL CC may be performed based on one of the following schemes.

a-i) fixedly setting a linkage in a total system

a-ii) setting a linkage for each eNB

a-iii) setting a linkage for each user group configured by an eNB

When a DL CC that has an linkage with a UL CC is incapable of performing a procedure to set a TA value, for example, a DL ECC or other CC types, one of the following schemes may be used so as to share a TA value obtained by a UL CC having a linkage with a DL CC that is capable of performing a TA value obtaining procedure.

b-i) setting a UL CC that refers to a TA value fixedly in a system

b-ii) setting a UL CC that refers to the same TA value with respect to all users in each eNB

b-iii) setting a UL CC that flexibly refers to a TA value for each user or for each user group

Also, irrespective of whether a DL CC is capable of performing a procedure to set a TA value, when a UL CC having the linkage is incapable of performing the procedure to set the TA value, for example, a UL ECC or other CC types, one of the following schemes may be used so as to share a TA value that is obtained by a UL CC that is capable of performing the TA value obtaining procedure and that has a linkage with a DL CC that is cable of performing the TA value obtaining procedure.

c-i) setting a UL CC that refers to a TA value fixedly in a system

c-ii) setting a UL CC that flexibly refers to a TA value with respect to all users in an eNB

c-iii) setting a UL CC that flexibly refers to a TA value for each user or for each user group

The UE 498 may simultaneously receive an RAR with respect to a simultaneously transmitted random access preamble, from the eNB 499 (step S440). In this example, UL grant information and TA information may be received together. The UL grant information may include information associated with frequency resources to be used by the UE.

Also, the simultaneously transmitted random access preamble may be transmitted for each CC, and the UE 498 may receive a random access response for each CC from the eNB 499.

The UE 498 may simultaneously perform CR for each CC (step S450), and may determine the validity of a received TA for each CC. In this example, when the UE 498 determines that the received TA has similarity, that is, when the TA value is within a threshold of a predetermined error range, the validity of the TA value may be acknowledged. The threshold of the predetermined error range may be variably set for an accuracy of a UL timing. That is, a narrower error range may be defined to secure a reliability of a timing.

The UE 498 may configure CCs to be in a UL timing group again, based on the received TA values of CCs (step S460). The TA value may be an example of UL synchronization information required when the UE adjusts a UL transmission time.

In a process of forming the UL timing group, the following conditions may need to be taken into consideration.

First, in a scheme of determining whether to assign CCs from among a plurality of CCs to different groups, the following conditions may be taken into consideration. That is, a CC that satisfies at least one condition may be configured to be a different group.

d-i) CCs, of which a difference in center frequency values is greater than or equal to a threshold, are assigned to different groups. When a difference in the center to frequency values is high, a delay occurring in a wireless signal propagation process may be changed and thus, a difference in TA values may also increase.

d-ii) CCs to which different beamforming schemes are applied are assigned to different groups. TA values are highly likely to be different from each other when the beamforming schemes are different from each other.

d-iii) CCs that are set to be updated every time a UL synchronization update request exists are assigned to different groups. The setting may be included in SI set by the eNB 499 for transmission, or may be included in other messages for transmission.

d-iv) CCs that do not provide services in a macrocell or CCs that provide services in a space superposed on the macrocell by a femtocell, a picocell, a microcell, a relay, a repeater, and the like may have different characteristics from CCs that provide services by the macrocell and thus, the CCs are configured to be different groups.

d-v) a CC that has a UL synchronization update request from the eNB 499 may be a CC that has a changed synchronization and thus, the CC may be assigned to a different group.

As described in the foregoing, examples of a condition for setting CCs to be a UL timing group may be d-i) through d-v). In addition, CCs are configured to be a single group or to be different groups based on a radio wave propagation characteristic, a predetermined measurement value, and the like.

When one of the following conditions are satisfied, CCs may be configured to be a single group.

e-i) CCs, of which a difference in center frequency values is within a threshold range, may have similar propagation characteristic and thus, the CC may be configured to be a single group.

e-ii) CCs, to which the same beamforming scheme is applied, may be grouped into a single group

e-iii) CCs used in devices in the same radio network may be grouped into is a single group

e-iv) CCs that do not satisfy condition (a) for assigning CCs to different groups may be grouped into a single group

A method for the UE 498 to generate a group may include two schemes, that is, a scheme of generating groups by distinguishing CCs that belong to different groups and a scheme of generating a group by distinguishing CCs to be included in the same group. The two schemes may be used together or one of the two schemes may be used. Conditions to be used in a process of applying each scheme have been described in the foregoing.

Also, the UE may select a delegate CC in each UL timing group based on the following conditions (step S465). In this example, the delegate CC may be selected from among CCs that are capable of obtaining a TA value to be used for obtaining a UL synchronization, based on the following conditions.

f-i) a CC having a lowest center frequency value

f-ii) a CC having a center frequency value that is closest to a mean value

f-iii) a CC having a highest center frequency value

f-iv) a CC having a broadest frequency band

f-v) a CC having a smallest TA value in a group

f-vi) a CC having a largest TA value in a group

f-vii) a CC having a TA value that is closest to a mean value in a group

f-viii) a CC set for monitoring DL quality

Here, a CC may be defined to include a DL CC or both the DL CC and a UL CC, and may be defined to be a cell or a serving cell. In other words, the cell may be is defined by only DL frequency resources (for example, a CC) through which a wireless signal recognized by a UE reaches a predetermined area, and may be defined to be a pair of the DL frequency resources that is used by the UE to receive a signal from the eNB and UL frequency resources that is used by the UE to transmit a signal to the eNB. Therefore, with respect to only a UE that is able to form a plurality of CCs, the eNB may be able to form a plurality of serving cells to perform transmission and reception of data with the UE.

In this example, a PCell may indicate a single serving cell that provides a security input and NAS mobility information in an RRC establishment state or re-establishment state. Also, based on the capabilities of the UE, at least one cell may be configured to form a serving cell set with the PCell, and the at least one cell may be referred to as an SCell.

Accordingly, a serving cell set configured for a single UE may be configured of a single PCell or of a single PCell and at least one SCell. An adjacent cell in a frequency of the PCell and/or an adjacent cell in a frequency of the SCell may be in the same carrier frequency, adjacent cells in frequencies of the PCell and the SCell may be in different carrier frequencies.

Here, a CC set for monitoring the DL quality may include a SCell to to which a radio link monitoring (RLM) is defined. In particular, the RLM may include a process in which a UE monitors DL quality based on a cell-specific reference (CRS) signal so as to detect DL quality of a serving cell set between the UE and an eNB.

In this example, the UE may predict the DL quality based on predetermined parameters which are defined by a ratio of the measured CRS to energy of is control channels. The RLM may be set based on following conditions.

To predict the DL quality through the RLM, a value that expresses a ratio of reception energy of an RE (single sub-carrier in a single OFDM symbol) through which a PDCCH/physical control format indicator channel (PCFICH) is transmitted, to an average RE energy of the CRS based on a dB unit may be used as a criterion.

From among the parameters, a parameter Qₒᵤₜ that is a criterion to determine an out-of-sync state may be determined based on a parameter set for transmitting a PDCCH/PCFICH and a value of which a block error rate (BER) of hypothetical PDCCH (based on a DCI format 1A) transmission based on an error of the PCFICH is greater than or equal to 10%. The value may be different based on a number of antenna port through which the CRS is transmitted.

For example, when the CRS is transmitted through a single antenna port, a ratio of energy between the PDCCH and the CRS to be determined as Qₒᵤₜ may be based on 4 dB, and when the CRS is transmitted through two or more antenna ports, Qₒᵤₜ may be based on 1 dB. From among the parameters, a parameter Qᵢₙ, that is a criterion to determine synchronization restoration or in-sync state may be determined based on a value having a sufficiently large reliability when compared to Qₒᵤₜ.

That is, a parameter set for transmitting the PDCCH/PCFICH and a value of which a BER of hypothetical PDCCH (based on a DCI format 1C) transmission based on an error of the PCFICH is greater than or equal to 2% may be used. The value may be changed based on a number of antenna ports through which the CRS is transmitted.

For example, when the CRS is transmitted through a single antenna port a ratio of energy between the PDCCH and the CRS to be determined as Qᵢₙ, may be based is on 0 dB, and when the CRS is transmitted through two or more antenna ports, Qᵢₙ, may be based on −3 dB.

A reason that an energy ratio used for determining Qᵢₙ, is lower than Qₒᵤₜ, is that the energy ratio is based on the parameter set for transmitting the PDCCH/PCFICH and the BER of the hypothetical PDCCH transmission. The parameters set for transmitting the PDCCH/PCFICH may include a DCI format of a PDCCH, a number of OFDM symbols through which control information of a subframe is transmitted, an aggregation level indicating a self-duplication rate of the PDCCH, and the like. The parameters may be affected by a bandwidth of a DL. Qₒᵤₜ and Qᵢₙ, may be affected based on whether a UE performs discontinuous reception (DRX) with respect to a corresponding cell.

Therefore, the UE or the eNB may select a delegate CC in each group. In this example, the UE or the eNB may select the delegate CC by selecting an SCell including the delegate CC. In this example, the delegate CC or the SCell may be selected based on the conditions f-i) through f-vii), from among CCs that are capable of obtaining a TA value to be used for obtaining a UL synchronization.

In this example, according to a method of selecting a delegate CC for each UL timing group, the same criterion may be used for all groups or a different criterion may be used for each timing group. That is, the delegate CC may be selected based on a network state of each group, characteristics of CCs forming each group, and the like.

After setting a UL timing group and a corresponding delegate CC, when synchronization information may need to be changed or UL synchronization may need to be obtained, the UE 498 may proceed with step S470. In step S470, the UE 498 may be triggered, again, to measure a TA value that is set for the UL timing group. A case that needs to obtain the UL synchronization may include a case that requires the validity for the previously set UL synchronization due to a change in a communication environment, a movement of a UE, and the like, after the UE sets the UL timing group (selects the delegate CC).

Cases that require obtaining a UL synchronization may be as follows.

g-i) a case in which the eNB 499 requires re-establishment of the entire DL synchronization

g-ii) a case that initializes and retries all UL data transmission

g-iii) a case in which a time alignment (TA) timer of the UE 498 expires

The UE 498 may transmit a preamble to be used for obtaining a UL synchronization with respect to total available CC groups. Although a condition does not satisfy one of the cases described in the foregoing, when the UE 498 determines that it is required, the UE 498 may generate a random access preamble and may transmit the random access preamble to the eNB 499.

When measuring of a TA is required in a UL timing group, the selected random access preamble may be set to be transmitted through a CC selected as a delegate CC for each UL timing group, and the selected preamble may be transmitted by selecting to one of resources defined in SI of each CC (step S475).

That is, to secure a valid TA value to be used for obtaining a UL synchronization, the UE 498 may set a preamble, and may transmit the set preamble by selecting one of the resources defined in SI of each CC through a delegate CC for each group, and a corresponding signal may be simultaneously transmitted by the UE through is time/frequency resources set by the eNB.

Simultaneous transmission may indicate that the preamble is transmitted through two or more CCs in parallel. Therefore, preamble transmission in step S475 may indicate that K transmissions are simultaneously performed through K UL timing groups. Here, a total number of CCs assigned to the UE is N, and K may be a value less than or equal to N. That is, when K=N, a single CC is configured to be a single UL timing group, and when K<N, two or more CCs are configured to be a single UL timing group.

For example, in steps S460 and S465, CC1, CC2, CC3, CC4, and CC5 exist, and CC1 and CC2 are configured to be group 1, CC3 and CC4 are configured to be group 2, and CC5 is configured to be group 3. A delegate CC of group 1 is CC1, a delegate CC of group 2 is CC3, and a delegate CC of group 3 is CC5. In this example, when a UL synchronization for the total available CC groups is required, the UE 498 may transmit a random access preamble through CC1, CC3, and CC5, simultaneously (in parallel). When synchronization needs to be obtained for a few CC groups, that is, when synchronization needs to be obtained for group 1 and group 2, excluding group 3, the UE 498 may simultaneously transmit a random access preamble through CC1 and CC3.

When a UL synchronization needs to be re-established while data is transmitted through a UL, the UE 498 may perform the following operation first, for example, initializing UL data transmission, and then may perform initializing HARQ buffers, releasing a physical uplink control channel (PUCCH)/sounding reference signal (SRS), initializing semi-persistent scheduling allocation/allowance, and the like, as a procedure to obtain a UL synchronization.

The eNB 499 may determine a TA value for each group with respect to each CC group (each delegate CC) based on the received random access preamble signal, and may recalculate the TA value. The eNB 499 may simultaneously transmit, to the UE 498, UL grant information and a TA value of a UL timing group (a delegate CC) through a random access response message (step S480).

Subsequently, when the UE 498 determines that the TA value received in the CR procedure (step S485) that is simultaneously performed for each delegate CC is valid, the UE 498 may apply the TA value to the UL timing group so as to obtain synchronization. In this example, the received TA value may be applied to remaining CCs in each UL timing group for updating (step S490).

As described in the foregoing, when a procedure of obtaining a UL synchronization is performed with respect to all groups, TA values associated with CC1, CC3, and CC5 may be applied to CCs included in group 1, group 2, and group 3, which are the UL timing groups where CC1, CC3, and CC5 belong, respectively. When a TA value of CC3 is received for group 2, the TA value may be applied to CCs included in group 2.

FIG. 5 illustrates a process that obtains a UL synchronization according to another embodiment of the present invention.

Referring to FIG. 5, when an RRC connection mode is an RRC_CONNECTED mode indicating that a UE 598 and an eNB 599 are connected, step S505 may be performed. When the RRC connection mode is an IDLE mode or requires resetting, step S502 may be performed first and then step S510 is performed. A PCell may be used for the RRC connection, and steps S502 and S505 may be performed in the is same manner as or similar to steps S402 and S405 of FIG. 4.

The eNB 599 may define a CC set based on a performance of hardware of the UE 498 and available frequency resources of the eNB 499 so as to allow the UE 598 to use a plurality of CCs. The eNB 599 may transmit, to the UE 598, CC set information of the CC set allowed for the UE 598 (step S505).

The CC set information may include CC IDs corresponding to the CCs included in the CC set, index information indicating each CC, offset information indicating another CC based on at least one CC, and the like. The CC set information may further include set ID information to distinguish each CC set formed of at least one CC. The CC set information may be received via a primary CC (PCC) or a PCell. The PCC may correspond to the PCell as described in the foregoing. A UE in an IDLE mode may select a single DL CC based on the condition for an RRC connection, and may receive SI through a broadcasting channel through which the selected CC. The CC set information may be transmitted through an RRC message.

The UE 598 may receive CC set information determined based on the condition, from the eNB 599 (step S505). According to a scheme of transceiving the CC set information, the eNB 599 may include the CC set information in an RRC reconfiguration message for transmission, and other messages may be used for transmission. That is, a CC set information message provided for each UE may be an RRC (L3) message, an L1 signaling, or an L2 signaling.

The UE 598 may receive SI associated with CCs in the CC set, based on the received CC set information (step S510). The SI may include center frequency information of each CC, information associated with a total frequency band of a corresponding CC, and the like.

When a CC (for example, an ECC) that is incapable of transmitting SI exists from among the CCs in the CC set, SI may be received through a CC that is capable of receiving the SI or through a predetermined CC that is capable of receiving the SI that is transformed in a form of control information.

The UE 598 may configure a UL timing group based on the received CC set information and the SI information, and each UL timing group may be configured to include a single CC (step S520). That is, a single CC may be configured to be a single group, and subsequently, the CCs may be configured to be a UL timing group.

The UL timing group is formed by including a plurality of CCs in a single group based on a predetermined condition, and CCs included in the UL timing group may be synchronized at the same time of a synchronization process or may be synchronized in the same manner as the synchronization process. For example, a case of applying the same TA value determined in the corresponding UL timing group may be included.

The UE 598 may select and set a predetermined random access preamble from among a plurality of preamble sets so as to obtain a UL timing, that is, may select a signal based on resource information defined in SI of each CC, and may transmit the corresponding signal through each UL CC of the UL timing group, (step S530).

According to the method of transmitting the corresponding signal, transmission may be simultaneously performed by the UE through use of time/frequency resources set by the eNB. Simultaneous transmission may indicate that the preamble is transmitted through two or more CCs in parallel.

A method of setting a linkage between a DL CC and a UL CC, which is a is reference for measuring a TA value with respect to a single UL CC may be performed based on condition a of FIG. 4.

In a case of an ECC, a TA value may be set by sharing a TA value obtained by a UL CC having a linkage with a DL CC that is capable of performing a TA value obtaining procedure.

The UE 598 may simultaneously receive an RAR with respect to a simultaneously transmitted random access preamble, from the eNB 599 (step S540). In this example, UL grant information and TA information may be received together. The UL grant information may include information associated with frequency resources to be used by the UE. The simultaneously transmitted random access preamble may be transmitted for each CC, and the UE 598 may receive a random access response for each CC. The preamble may be included in a synchronization request message through which the UE requests synchronization.

The UE 598 may simultaneously perform CR for each CC (step S550), may determine validities of received TA values, and may configure CCs of which TA values have similarities (TA values within a threshold of an error range) to be in a single UL timing group (step S560). The threshold of the predetermined error range may be variably set for an accuracy of a UL timing.

The UE 598 may distinguish each CC based on the condition d and the condition e of FIG. 4, propagation characteristic, a predetermined measurement value, and the like, so as to configure CCs to be in different UL timing groups, or to be in the same UL timing group. Also, the two schemes may be used separately or may be used together.

Also, UE may select a delegate CC in each UL timing group based on the following conditions (step S565).

In this example, the delegate CC may be selected from among CCs that are capable of obtaining a TA value to be used for obtaining a UL synchronization, based on the condition f of FIG. 4. In this example, according to a method of selecting a delegate CC for each UL timing group, the same criterion may be used for all groups or a different criterion may be used for each timing group. That is, the delegate CC may be selected based on a network state of each group, characteristics of CCs forming each group, and the like.

After configuring a UL timing group and a corresponding delegate CC are set, the UE 598 may be triggered, again, to reconfigure a timing group that is configured for the UL timing group (step S570).

The timing group may need to be reconfigured based on the following conditions.

h-i) CC set is changed through reconfiguration of an RRC connection between the eNB and the UE.

h-ii) A response is not obtained in response to UL transmission data transmitted through a few UL CCs of CCs in a group of a UE.

h-iii) A UE performs handover of a few CCs to an physically different eNB.

h-iv) An eNB requests reconfiguration with respect to a few CCs in a group associated with a DL synchronization.

h-v) A CC time alignment (TA) timer expires (the timer is set for each CC is or for each group).

h-vi) A change occurs in a DL/UL linkage setting in an eNB, provided in step S530.

h-vii) A change occurs in a group and a DL/UL linkage setting provided in step S530.

Accordingly, when the UL timing group needs to be reconfigured, the UE 598 may initialize the UL timing group first so as to reconfigure the UL timing group (step S572), and enables each CC to be the UL timing group (step S574).

Subsequently, a random access preamble is set for each CC in each UL timing group, and a random access preamble signal selected based on SI of each CC may be transmitted (step S575). In this example, the UE 598 may transmit the preamble through two or more CCs in parallel.

The eNB 599 may calculate a TA value for each CC, based on the received random access preamble signal. The eNB 599 may simultaneously transmit, to the UE 598, UL grant information and a TA value of a CC through a random access response message (step S580).

Subsequently, when the UE 598 determines that the TA value received in a CR procedure (S585), which is simultaneously performed for each CC, is valid, the UE 598 may reconfigure the UL timing group as described in step S560 based on the corresponding TA value (step S590). A delegate CC may be selected for the reconfigured UL timing group, and conditions used for the process of reconfiguring the UL timing group and selecting the delegate CC may be the same as steps S560 and S565. The TA value may be an example of UL synchronization information required when the UE adjusts a UL transmission time.

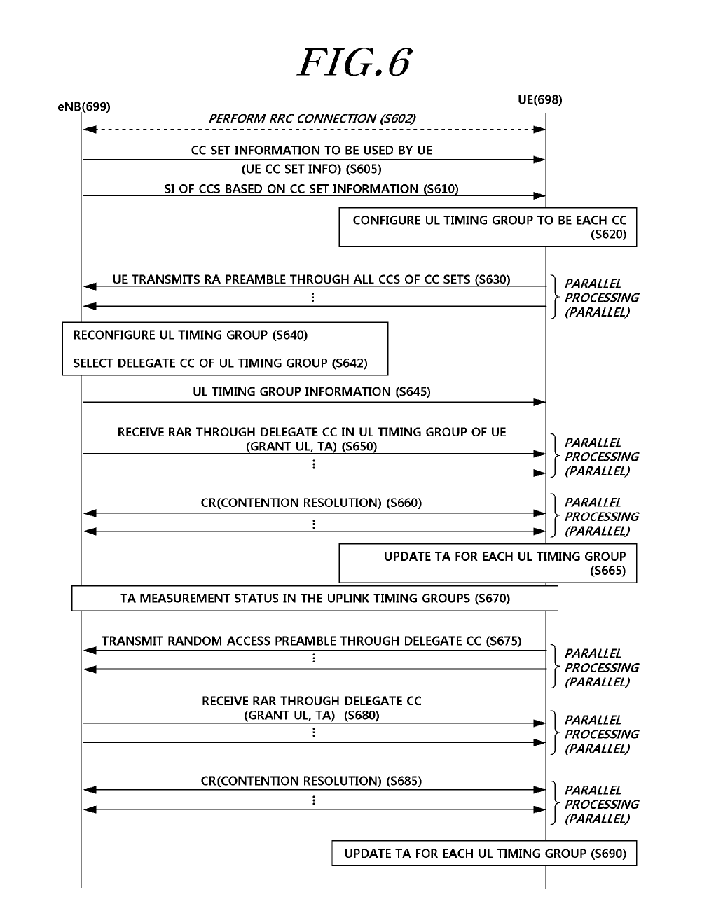

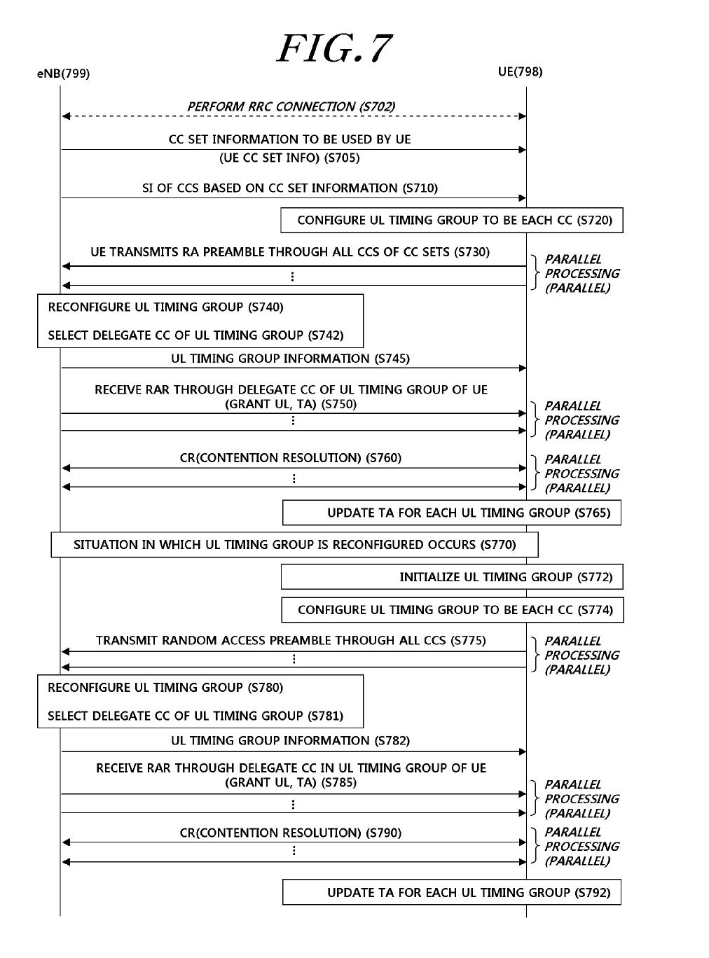

FIGS. 6 and 7 illustrate a UL synchronization obtaining procedure according to embodiments of the present invention. An eNB may transmit information associated with a plurality of CCs to a UE, may configure a group associated with a timing from among the CCs, may select a delegate CC, and may transmit relevant information to the UE. The UE may perform a RAP through the received UL timing group information and information associated with the delegate CC.

FIG. 6 illustrates a process that obtains a UL synchronization according to an embodiment of the present invention.

Referring to FIG. 6, when an RRC connection mode is an RRC_CONNECTED mode indicating that a UE 698 and an eNB 699 are connected, step S605 may be performed. When the RRC connection mode is an IDLE mode or requires resetting, step S602 may be performed first and then step S610 is performed. A PCell may be used for the RRC connection, and steps S602 and S605 may be performed in the same manner as or similar to steps S402 and S405 of FIG. 4.

The eNB 699 may allow the UE 698 to use a plurality of CCs based on a performance of hardware of the UE 698 and available frequency resources of the eNB 699, and define the plurality of CCs to be a CC set. CC set information of the CC set may include CC IDs corresponding to the CCs included in the CC set, index information indicating each CC, offset information indicating another CC based on at least one CC, and the like. The CC set information may further include set ID information to distinguish each CC set formed of at least one CC.

The eNB 699 may transmit, to the UE 698, the CC set information of the CC set allowed to the UE 698 (step S605). Here, the UE 698 and the eNB 699 maintain an RRC_CONNECTED mode from step S602 or before. Accordingly, the UE 698 may receive the CC set information determined as described in the foregoing, from the eNB 699 (step S605). To transmit the CC set information, an RRC reconfiguration message may be used.

The UE 698 may receive SI associated with CCs in the CC set, based on the received CC set information (step S610). The SI may include center frequency information of each CC, information associated with a total frequency band of a corresponding CC, a frame structure of a corresponding CC, RAP information, and the like.

When a CC (for example, an ECC) that is incapable for transmitting exists in CCs of the CC set, the SI associated with the ECC may be transmitted through a predetermined CC that is receivable or may be transformed in a form of control information of the CC and may be transmitted through the receivable CC.

The UE 698 may configure a UL timing group based on the received CC set information and the SI information, and each UL timing group may be configured to include a single CC (step S620). That is, a single CC may be configured to be a single group, and subsequently, the CCs are configured to be a UL timing group.

For example, when CC set information of a CC set including three CCs, that is, CC1, CC2, and CC3, is received in step S605, and SI information associated with the three CCs, that is, CC1, CC2, and CC3, is received in step S610, a first group including only CC1, a second group including only CC2, and a third group including only CC3 may be configured to be the UL timing group.

Therefore, the UL timing group may be configured by including a plurality of CCs into a single group based on a predetermined condition, and CCs included in the UL timing group may be synchronized at the same time of a synchronization process or may be synchronized in the same manner as the synchronization process. Also, each UL timing group may indicate each group to which a distinguished TA value is equally applied.

The UE 498 may select and set a predetermined random access preamble from among a plurality of preamble sets to obtain a UL timing, and may transmit, to the eNB 499, a preamble signal selected based on resource information defined in SI of each CC, through each UL CC of the UL timing group (step S630). The preamble may be included in a synchronization request message through which the UE requests synchronization.

According to the method of transmitting the corresponding signal, the preamble may be transmitted through two or more CCs in parallel. In this example, the selected preamble may be transmitted through a corresponding CC of each UL timing group in parallel.

A method of setting a linkage between a DL CC and a UL CC, which is a reference for measuring a TA value with respect to a single UL CC may be performed based on the condition a of FIG. 4.

When a DL CC that has a linkage with a UL CC is incapable of performing a procedure to set a TA value, for example, an ECC, a TA value may be set by sharing a TA value obtained by a UL CC having a linkage with a DL CC that is capable of performing a TA value obtaining procedure. In this example, the condition b is of FIG. 4 may be used.

Also, irrespective of whether a DL CC is capable of performing a procedure to set a TA value, when a UL CC having a linkage is incapable of performing the procedure to set the TA value, a TA value of an ECC may be obtained based on the condition c of FIG. 4.

The eNB 699 may calculate a TA value for each CC with respect to the random access preamble that is simultaneously transmitted by the UE 698, and may reconfigure CCs of which TA values have similarities (TA values within a threshold of an error range) to be in a single UL timing group (step S640). The threshold of the error range may be variably set for an accuracy of a UL timing. That is, a narrower error range may be defined to secure a reliability of a timing. The UL timing group may be configured based on the condition d and the condition e of FIG. 4.

Also, the eNB 699 may select a delegate CC of each group based on a few conditions in each UL timing group (step S642). In this example, the delegate CC may be selected based on the condition f of FIG. 4.

When a delegate CC is selected for each UL timing group, the same criterion may be applied to all groups or a different criterion may be applied for each group. That is, the delegate CC may be selected based on a network state of each group, characteristics of CCs forming each group, and the like.

The eNB 699 may transmit UL timing group information associated with the set UL timing group (step S645), and may transmit a TA value for each group through a delegate CC of each timing group, as a random access response (RAR), simultaneously (in parallel) (step S650). Here, the UL timing group information may not is be included in a CC set information message and the like, and may be transmitted through a separate message. The UL timing group information may be transmitted through a channel such as a PDCCH, an RRC signaling, a broadcasting channel, and may be transmitted through an L2 (MAC element control) message. Also, the RAR message may include UL grant information corresponding to information associated with frequency resources to be used by the UE, and TA information.

The UE 698 may simultaneously receive a TA value of a delegate CC of each group based on the received UL timing group information, may perform a CR procedure in parallel (step S660) so as to determine the validity of the received TA value, and may update a TA value for each group (step S665). A CC in which the RAR is performed in step S650 may be set to be a delegate CC by the eNB 699 and thus, the UE 698 may set the CC in which the RAR is performed to be a delegate CC in a corresponding group. The UE 698 that receives the CC set information message may use the received UL timing group as it is, or may slightly change the UL timing group based on a current network state. This may also include a case in which the UE 698 changes a group when the group generated by the eNB 699 is inappropriate for an environment of the UE 698. The TA value may be an example of UL synchronization information required when the UE adjusts a UL transmission time.

When synchronization information needs to be changed or UL synchronization needs to be obtained after the UL timing group is configured and a delegate CC is selected for the corresponding group, the UE 698 may perform step S670. That is, in step S670, the UE 498 may be triggered, again, to measure a TA value that is set for the UL timing group. The UL synchronization may need to be obtained when one is of the condition g of FIG. 4 is satisfied.

Accordingly, the UE 698 may transmit a preamble to be used for obtaining a UL synchronization with respect to total available CC groups. That is, when the UL synchronization needs to be obtained, a random access preamble may be set for each CC that is set as a delegate CC in a UL timing group and a corresponding signal may be transmitted by selecting one of resources defined in SI of each CC (step S675). In this example, the UE 698 may transmit the preamble through two or more CCs in parallel.

For example, in steps S640 and S642, CC1, CC2, CC3, CC4, and CC5 may exist and CC1 and CC2 are configured to be group 1, CC3 and CC4 are configured to be group 2, and CC5 is configured to be group 3. A delegate CC of group 1 is CC1, a delegate CC of group 2 is CC3, and a delegate CC of group 3 is CC5. In this example, when a UL synchronization for total available CC groups is required, the UE 698 may transmit a random access preamble through CC1, CC3, and CC5, simultaneously (in parallel).

When synchronization needs to be obtained for a few CC groups, that is, when synchronization needs to be obtained for group 1 and group 2, excluding group 3, the UE 698 may simultaneously transmit a random access preamble through CC1 and CC3.

When a UL synchronization needs to be re-established while data is transmitted through a UL, the UE 698 may perform the following operation first, for example, initializing UL data transmission, and then may perform initializing HARQ buffers, releasing a physical uplink control channel (PUCCH)/sounding reference signal (SRS), initializing semi-persistent scheduling allocation/allowance, and the like, as a is procedure to obtain a UL synchronization.

The eNB 699 may calculate a TA value for each UL timing group with respect to each CC group (each delegate CC) based on the received random access preamble signal. The eNB 699 may simultaneously transmit, to the UE 698, UL grant information and a TA value of a UL timing group (a delegate CC) through a random access response message (step S680).

Subsequently, when the UE 698 determines that the TA value received in the CR procedure (step S685), which is simultaneously performed for each delegate CC, is valid, the UE 698 may apply the TA value to remaining CCs in each group for updating (step S690).

As described in the foregoing, when a procedure of obtaining a UL synchronization is performed with respect to all groups, TA values associated with CC1, CC3, and CC5 may be applied to CCs included in group 1, group 2, and group 3. When a TA value of CC3 is received for group 2, the TA value may be applied to CCs included in group 2.

FIG. 7 illustrates a process that obtains a UL synchronization according to another embodiment of the present invention.

Referring to FIG. 7, when an RRC connection mode is an RRC_CONNECTED mode indicating that a UE 798 and an eNB 799 are connected, step S705 may be performed. When the RRC connection mode is an IDLE mode or requires resetting, step S702 may be performed first and then step S710 may be performed. A PCell may be used for the RRC connection, and steps S702 and S705 may be performed in the same manner as or similar to steps S402 and S405 of FIG. 4.

The eNB 799 may allow the UE 798 to use a plurality of CCs based on a performance of hardware of the UE 798 and available frequency resources of the eNB 799, and define the plurality of CCs to be a CC set. CC set information of the CC set may include CC IDs corresponding to the CCs included in the CC set, index information indicating each CC, offset information indicating another CC based on at least one CC, and the like. The CC set information may further include set ID information to distinguish each CC set formed of at least one CC.

The eNB 799 may transmit, to the UE 698, the CC set information of the CC set allowed to the UE 798 (step S705). Accordingly, the UE 798 may receive the CC set information determined as described in the foregoing, from the eNB 799 (step S705). To transmit the CC set information, an RRC reconfiguration message may be used.

The UE 798 may receive SI associated with CCs in the CC set, based on the received CC set information (step S710). The SI may include center frequency information of each CC, information associated with a total frequency band of a corresponding CC, and the like.

When a CC (for example, an ECC) that is incapable for transmitting exists in CCs of the CC set, the SI associated with the ECC may be transmitted through a predetermined CC that is receivable or may be transformed in a form of control to information and may be received.

The UE 798 may configure a UL timing group based on the received CC set information and the SI information, and each UL timing group may be configured to include a single CC (step S720). That is, a single CC may be configured to be a single group, and subsequently, the CCs are configured to be a UL timing group.

For example, when CC set information of a CC set including three CCs, that is, CC1, CC2, and CC3, is received in step S705, and SI information associated with the three CCs, that is, CC1, CC2, and CC3, is received in step S710, a first group including only CC1, a second group including only CC2, and a third group including only CC3 may be configured to be the UL timing group. Therefore, the UL timing group may be configured by including a plurality of CCs into a single group based on a predetermined condition, and CCs included in the UL timing group may be synchronized at the same time of a synchronization process or may be synchronized in the same manner as the synchronization process. Also, each UL timing group may indicate each group to which a distinguished TA value is equally applied.

The UE 798 may selectively set a random access preamble for each UL CC so that the eNB 799 configures a UL timing group, and may transmit a corresponding signal by selecting one of resource information defined in SI of each CC (step S730). The preamble may be included in a synchronization request message through which the UE requests synchronization.

According to the method of transmitting the corresponding signal, transmission may be simultaneously performed by the UE through use of time/frequency resources set by the eNB. Simultaneous transmission may indicate that the preamble is transmitted through two or more CCs in parallel.

A method of setting a linkage between a DL CC and a UL CC, which is a reference for measuring a TA value with respect to a single UL CC may be performed by selecting one of the following schemes.

When a DL CC that has a linkage with a UL CC is incapable of is performing a procedure to set a TA value, for example, an ECC, a TA value may be set by sharing a TA value obtained by a UL CC having a linkage with a DL CC that is capable of performing a TA value obtaining procedure.

Also, irrespective of whether a DL CC is capable of performing a procedure to set a TA value, when a UL CC having a linkage is incapable of performing the procedure to set the TA value, a TA value of an ECC may be obtained based on the condition c of FIG. 4.

The eNB 799 may calculate a TA value for each CC with respect to the random access preamble that is simultaneously transmitted by the UE 798, and may reconfigure CCs of which TA values have similarities (TA values within a threshold of an error range) to be in a single UL timing group (step S740). The threshold of the error range may be variably set for an accuracy of a UL timing. That is, a narrower error range may be defined to secure a reliability of a timing.

The UL timing group may be configured based on the condition d and the condition e of FIG. 4.

Also, the eNB 699 may select a delegate CC of each group based on a few conditions in each UL timing group (step S742). In this example, the delegate may be selected based on the condition f of FIG. 4, from among CCs that are capable of obtaining TA values to be used for obtaining a UL synchronization.

When a delegate CC is selected for each UL timing group, the same criterion may be applied to all groups or a different criterion may be applied for each group. That is, the delegate CC may be selected based on a network state of each group, characteristics of CCs forming each group, and the like.

The eNB 699 may transmit UL timing group information associated with the set UL timing group (step S745), and may transmit a TA value for each group through a delegate CC of each timing group, as an RAR, simultaneously (in parallel) (step S750). The RAR message may include UL grant information corresponding to information associated with frequency resources to be used by the UE, and TA information.

The UE 798 may simultaneously receive a TA value of a delegate CC of each group based on the received UL timing group information, may perform a CR procedure in parallel (step S760) so as to determine the validity of the received TA value, and may update a TA value for each group (step S765). A CC in which the RAR is performed in step S750 may be set to be a delegate CC by the eNB 799 and thus, the UE 798 may set the CC in which the RAR is performed to be a delegate CC in a corresponding group.

Subsequently, when a UL timing group needs to be reconfigured after a predetermined time or due to a change in a communication environment, movement of the UE, and the like (step S570), that is, when at least one of the condition h of FIG. 5 is satisfied, the UE 798 may initialize the UL timing group first for reconfiguration (step S772), and may configure the UL timing group to be each single CC (step S774).

The UE 798 may set a random access preamble for each CC in each UL timing group, and may transmit the selected preamble to the eNB 799 based on SI of each CC (step S775). In this example, the preamble may be transmitted through two or more CCs in parallel. That is, a total number of CCs assigned to the UE 798 may be N, and the preamble may be transmitted through N CCs since the UL timing group is initialized.

The eNB 799 may calculate a TA value for each CC based on the received random access preamble signal. The eNB 799 may calculate a TA value for each CC, and may reconfigure CCs of which TA values have similarities (TA values within a threshold of an error range) to be in a single UL timing group (step S780). Conditions to be taken into consideration when the UL timing group is reconfigured may be the same as the conditions described in step S740.

The eNB 799 may select a delegate CC for each group based on a few conditions in each UL timing group (step S782). In this example, the delegate CC may be selected based on the same condition as described in step S742, from among CCs that are capable of obtaining TA values to be used for obtaining a UL synchronization.

The eNB 799 may transmit UL timing group information associated with the set UL timing group (step S782), and may transmit a TA value for each group and the UL grant information, as an RAR, simultaneously (in parallel) (step S785). The UE may simultaneously receive a TA value of a delegate CC of each group based on the simultaneously received UL timing group information, may perform a CR procedure in parallel (step S790) so as to determine the validity of the received TA value, and may update a TA value for each group (step S792). The TA value may be an example of UL synchronization information required when the UE adjusts a UL transmission time.

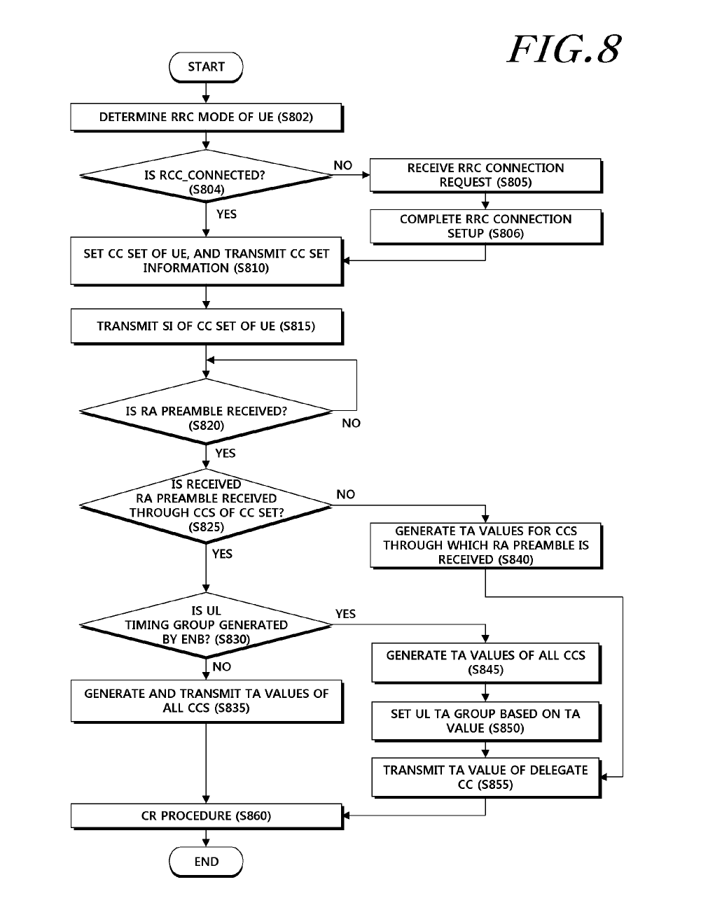

FIG. 8 illustrates an eNB that enables a UE to obtain a UL synchronization according to an embodiment of the present invention. FIGS. 4, 5, 6, and 7 may show a procedure performed for obtaining a UL synchronization in an eNB.

Referring to FIG. 8, the eNB may determine an RRC mode of the UE (step S802). When an RRC connection mode between the eNB and the UE is an RRC_CONNECTED mode (step S804), step S810 may be performed.

When the RRC connection mode is different from the RRC_CONNECTED mode, an RRC connection request may be received from the UE (step S805), and RRC connection setup may be completed (step S806). In this example, the eNB may receive an RRC connection request message from the UE, may transmit an RRC connection setup message to the UE, and may receive an RRC connection setup complete message from the UE and may complete the RRC connection setup.

The eNB may configure a CC set including at least one CC that is available to the UE, and may transmit CC set information of the CC set (step S810), and may transmit SI associated with the CC set of the UE (step S815). Here, the CC set information may be transmitted through an RRC message. Also, the SI of the CC set may be transmitted through a broadcasting channel.

Subsequently, the eNB may determine whether a random access (RA) preamble is received from the UE (step S820). When the RA preamble is not received, the eNB may wait until it receives the RA preamble.

When the RA preamble is received, the received RA preamble signal is received simultaneously (in parallel) through corresponding CCs of the entire CC set (step S825). When the RA preamble is received through a few CCs, it may indicate that the UE generates a UL timing group and transmits the RA preamble through a delegate CC and thus, TA values associated with the CCs (delegate CCs) through which the RA preamble is received may be generated (step S840). Also, a TA value of a delegate CC of a group may be transmitted (step S855), and a CR procedure may be performed so that the UE may determine the validity of the TA value.

When the RA preamble signal is received through the entire CC set (step S825) and a UL timing group is generated by the eNB (step S835), the eNB may generate TA values of the CCs of the entire CC set (step S845), and may configure a UL timing group based on the TA values (step S850). In this process, a delegate CC may also be selected for the UL timing group. A TA value of the delegate CC of the group may be transmitted (step S855). In this example, when the eNB generates a UL timing group, the eNB may generate the UL timing group based on CC set information, and may transmit UL timing group information to the UE. Here, the UL timing group information may be generated at the same point in time when the CC set information is generated and transmitted in step S810, or may be transmitted together with the CC set information.

Subsequently, a CR procedure may be performed with respect to the UL timing group so that the UE may determine the validity of the TA value (step S860).

When the RA preamble signal is received through the entire CC set (step S825) and the UL timing group is not generated by the eNB (step S835), TA values of all CCs may be generated and may be transmitted to the UE through all the CCs (step S835), and a CR procedure may be performed so that the UE may determine the validity of TA values (step S860). Here, the eNB may transmit a random access response message with respect to the received preamble. In this example, UL grant information of the UE and TA information for each UL timing group may be transmitted through all the CCs. Here, the TA information for each UL timing group may be transmitted in a form of a table including a TA value corresponding to a group index, and may be transmitted in a form including a unit error for each timing group based on a reference TA value. In this example, the error for each group may be expressed by an integer-multiple of a is predetermined unit value, or may be specified in detail. The TA information for each UL timing group may be transmitted in a form of an indicator indicating a TA based on a predetermined rule.

The eNB may simultaneously perform transmission and reception of a signal with a UE based on a plurality of CCs. Throughout FIGS. 4, 5, 6, and 7, the eNB that operates a plurality of CCs may set a CC set to be used by the UE, and may transmit CC set information of the CC set to the UE, and may simultaneously receive a message requesting synchronization through CCs included in a first group which corresponds to a few or all of CCs forming the CC set. Also, the eNB may simultaneously transmit information associated with synchronization in response to the received message, through CCs included in a second group which corresponds to a portion or all of the CC set.

A case that performs transmission and reception through all the CCs forming the CC set may include steps S430 and S440 of FIG. 4, steps S530 and S540 of FIG. 5, and the like. When transmission and reception is performed through a delegate CC of a UL timing group, an RA preamble may be received through a first CC which is a portion of the CC set, and an RA response process may be performed through a CC (a delegate CC) included in a corresponding second group. Also, when the eNB generates a UL timing group, an RA preamble may be received through a CC included in a first group corresponding to the entire CC set, a timing group may be generated, and an RA response message may be transmitted through a delegate CC which is a portion of the entire CC set. Steps S640 and S650 of FIG. 6 and steps S740 and S780 of FIG. 7 may be relevant examples.

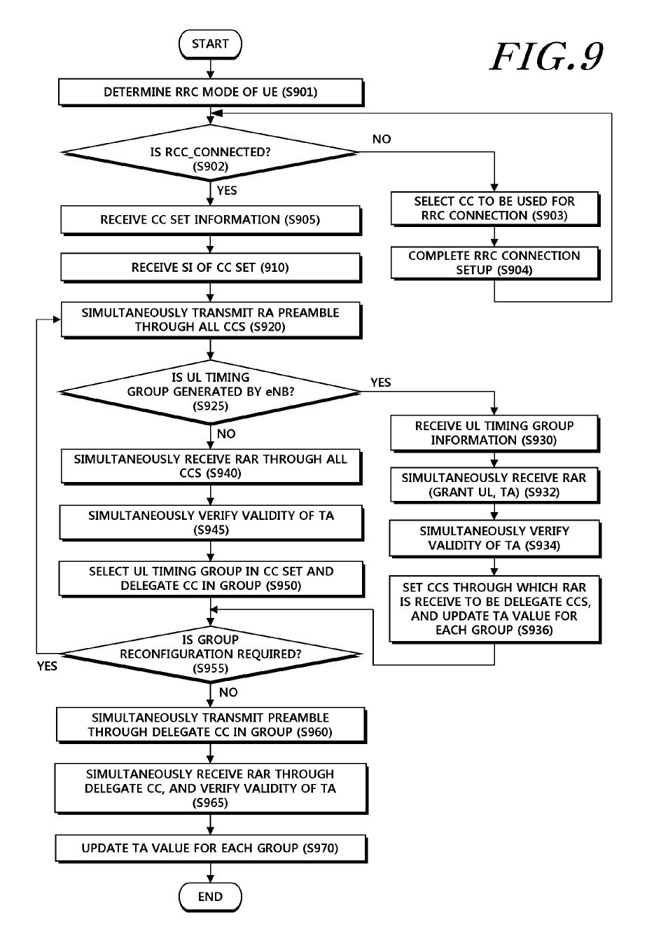

FIG. 9 illustrates a UE that obtains a UL synchronization according to an is embodiment.

Referring to FIG. 9, the UE may determine an RRC mode (step S901). When an RRC connection mode is an RRC_CONNECTED mode in step S902, step S905 may be performed. When the RRC connection mode is different from the RRC_CONNECTED mode, the UE may select a CC through which RRC connection is set up (step S903), and may complete RRC connection setup (step S904). That is, the UE may transmit an RRC connection request message through the selected CC, may receive, from an eNB, an RRC connection setup message through the selected CC, and may transmit an RRC connection setup complete message to the eNB so as to complete the RRC connection setup.

The UE may receive CC set information of CCs from the eNB (step S905), and may receive SI information of the CC set (step S910).

An RA preamble may be simultaneously transmitted through all CCs (step S920). Here, when the UE performs contention-based mode, the UE may select an RACH preamble for a predetermined CC based on the received CC set information and SI information, and may transmit, to the eNB, information associated with time/frequency resources of a corresponding CC associated with the selected preamble and the CC set information, and information associated with the RACH preamble to be transmitted through the corresponding CC.

When the UE performs non-contention based mode, the UE may transmit an RACH preamble based on RACH preamble information received from the eNB. Also, the UE may receive, from the eNB, information associated with time/frequency resources of a corresponding CC from among the CC set to which the RACH preamble is to be transmitted, and may transmit the RACH preamble through the corresponding time/frequency resources.

Whether UL timing group information is generated by the eNB may be determined (step S925). When the UL timing group information is generated by the eNB, the UE may receive the UL timing group information from the eNB (step S930), in the same manner as step S645 of FIG. 6 and step S745 of FIG. 7.

The UE may simultaneously receive an RA response through all CCs in each group, based on the received UL timing group information (step S932). The UE may simultaneously verify the validity of a TA value of each UL timing group received through a CR process. Each CC that receives an RA response may be set to be a delegate CC in a group, and may update a TA value for a corresponding group (step S936), in the same manner as steps S650 through 665 of FIG. 6 and steps S750 through S765 of FIG. 7.

When the UL timing group information is not generated by the eNB, an RA response is simultaneously received through all CCs (step S940). In this process, UL grant information and a TA value may also be received. In the CR process, the validity of the TA value may be simultaneously verified (step S945). A UL timing group may be configured in the CC set, and a delegate CC is selected in the group (step S950), in the same manner as steps S440 through 465 of FIG. 4, and steps S540 through S565 of FIG. 5.

When step S936 and step S950 are completed, whether group reconfiguration is required may be determined (step S955). When a case corresponds to step S570 of FIG. 5 or step S770 of FIG. 7, step S920 may be performed for group is reconfiguration.

A case that does not require the group reconfiguration may include a case that measures a TA in a UL timing group (step S470 of FIG. 4 and step S670 of FIG. 6). A delegate CC in a group may simultaneously transmit a preamble (step S960). An RA response may be simultaneously received through the delegate CC, and the validity of the TA may be verified in the CR process (step S965). Subsequently, the TA value received through the delegate CC may be used for updating TA values of remaining CCs in the group (step S970).

The UE may simultaneously perform transmission and reception of a signal with the eNB, based on a plurality of CCs. Throughout FIGS. 4, 5, 6, and 7, the UE that operates a plurality of CCs may receive CC set information from the eNB, and may simultaneously transmit, to the eNB, a message requesting synchronization through CCs included in a first group which corresponds to a few or all of CCs forming the CC set. Also, the UE may simultaneously receive information associated with the synchronization in response to the message received from the eNB, through CCs included in a second group which corresponds to a portion or all of the CC set.

A case that performs transmission and reception through all the CCs forming the CC set may include steps S430 and S440 of FIG. 4, steps S530 and S540 of FIG. 5, and the like. When transmission and reception is performed through a delegate CC of a UL timing group, an RA preamble may be transmitted through a first CC which is a portion of the CC set, and an RA response process may be performed through a CC (delegate CC) included in a corresponding second group. Also, when the eNB generates a UL timing group, an RA preamble may be transmitted through a CC included in a first is group corresponding to the entire CC set, a timing group may be generated, and an RA response message may be received through a delegate CC which is a portion of the entire CC set. Steps S640 and S650 of FIG. 6 and steps S740 and S780 of FIG. 7 may be relevant examples.

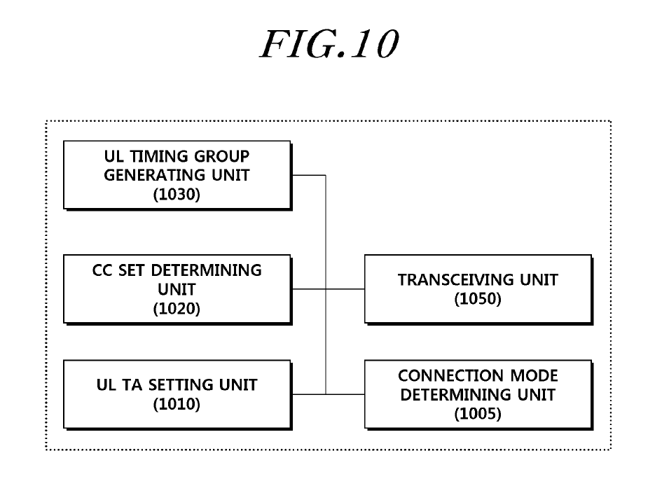

FIG. 10 illustrates a configuration of an eNB according to an embodiment of the present invention.

Referring to FIG. 10, a transmitting apparatus 1000 may include a connection mode determining unit 1005 to determine an RRC mode of a UE, a UL TA setting unit (UL synchronization establishing unit) 1010 to set a UL TA value, a CC set determining unit 1020 to determine a CC set including at least one CC available to the UE, a UL timing group generating unit 1030 to generate a UL timing group, and a transceiving unit 1050.

That is, the UL TA setting unit 1010 may generate UL synchronization information corresponding to the UL timing group, so as to establish the UL synchronization. The transceiving unit 1050 may simultaneously receive a synchronization request message from the UE through one or more delegate CCs in the UL timing group, and may simultaneously transmit the UL synchronization information to the UE through the one or more delegate CCs. Also, the UL timing group may be generated by the UE or the eNB so as to establish the UL synchronization. When the UL timing group is established, conditions d-i) through d-v) and e-i) through e-iv) may be taken into consideration.

The one or more delegate CCs may be selected by the UE or the eNB, based on a state of the UL timing group, and characteristics of a plurality of CCs forming is the UL timing group. When the delegate CC is selected, conditions f-i) through f-vii) may be taken into consideration.

The transceiving unit 1050 may simultaneously receive the synchronization request message from the UE through all CCs forming the CC set, before the UL group is generated by the UE or the eNB.

In particular, the connection mode determining unit 1005 may determine a connection mode between the UE and the eNB, and when the UE and the eNB are not connected, that is, when the connection mode is an RRC_IDLE mode or UL synchronization is not established, the connection mode determining unit 1005 may change the connection mode of the UE to an RRC_CONNECTED mode or may enable the UL synchronization to be established.

For example, the connection mode determining unit 1005 may receive an RRC connection request transmitted from the UE through use of the transceiving unit 1050, and may operate to transmit an RRC connection setup message to the UE. Also, the connection mode determining unit 1005 may receive an RRC connection setup complete message from the UE, may complete the RRC connection setup, and may determine an UE RRC_CONNECTED mode.

The CC set determining unit 1020 may determine one or more CCs available to the UE, and may set a CC set of the UE. In this example, the CC set for the UE may be set based on a difference in UL synchronization times of the available (configurable) CCs, type information of each CC, a center frequency location of each CC, a service type of each CC, a network service for each CC, and the like.

The UL timing group generating unit 1030 may generate the UL timing is group of the UE based on the CC set determined by the CC set determining unit 1020. Here, the UL timing group may be determined by comparing a difference in center frequency values of CCs with a threshold, determining whether the CCs have the same beamforming scheme or different beamforming schemes, determining whether the CCs are updated based on a UL synchronization update request, and determining whether the CCs correspond to CCs that are incapable of providing a service in a macrocell but are capable of providing a service in a space superposed by a cell smaller than the macrocell, such as a femtocell, a picocell, a micorcell, a relay, a repeater, and the like. The condition used for determining the UL timing group has been described in step 640 of FIG. 6 and step S740 of FIG. 7. Also, the UL timing group generating unit 1030 may select a delegate CC in a timing group as shown in step S642 of FIG. 6 and step S742 of FIG. 7. As described in the foregoing, the delegate CC may be selected based on the conditions f-i) through f-vii).

The UL TA setting unit 1010 may receive an RA preamble transmitted by the UE, and may calculate a TA value. The transceiving unit 1050 may transmit the TA value through a CC through which the RA preamble associated with the TA value is obtained, or may transmit the TA value through the delegate CC of the group generated by the UL timing group generating unit 1030. Transmission of the TA value may be performed by the transceiving unit 1050, through two or more CCs, simultaneously (in parallel).

The transceiving unit 1050 may transmit CC set information and UL timing group information to the UE. In this example, the transceiving unit 1050 may transmit the CC set information, and may additionally transmit SI.

The transceiving unit 1050 may simultaneously receive, from the UE, a message requesting synchronization, for example, a message including an RA preamble. That is, the RA preamble simultaneously received through the delegate CC determined by the UE for the UL timing group may be determined, and a TA value for each UL timing group may be simultaneously transmitted.

Also, the transceiving unit 1050 may simultaneously transmit a response to the RA preamble through the UL timing group and the delegate CC that are generated by the UL timing group generating unit 1030 through the RA preamble message transmitted from the UE.

In particular, the UL TA setting unit 1010 may calculate a TA value that adjusts a UL transmission time for each group corresponding to the UL timing group in response to the received synchronization request message, and the transceiving unit 1050 may transmit the calculated TA value to the UE through UL grant information for the UE and a random access response message.

Also, the UL TA setting unit 1010 may calculate the UL synchronization information by comparing, with a predetermined threshold, a difference in center frequency values of a plurality of CCs in the CC set configured for the UE, or may calculate the UL synchronization information to enable the CCs to have different transmission times by determining whether the CCs have the same beamforming scheme, whether the CCS are updated based on a synchronization update request, or whether the CCs correspond to CCs that are incapable of providing a service in a macrocell, but are capable of providing a service in a space superposed by a coverage cell smaller than the macrocell.

The component elements of FIG. 10 may be configured as a single module or as two or more modules, and the two or more modules may be configured to perform a single function.

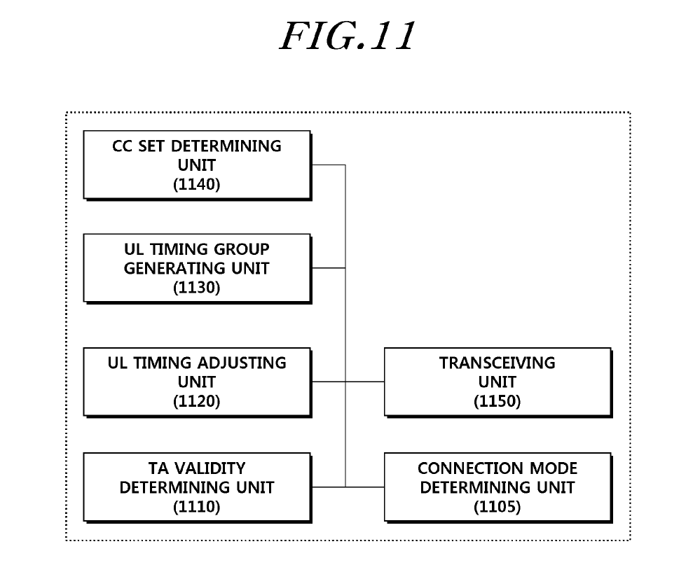

FIG. 11 illustrates a configuration of a receiving apparatus according to an embodiment of the present invention.

Referring to FIG. 11, a connection mode determining unit 1105, a CC set determining unit 1140, a UL timing adjusting unit 1120, a UL timing group generating unit 1130, a TA validity determining unit 1110, and a transceiving unit 1150.

The transceiving unit 1150 may simultaneously transmit a synchronization request message to an eNB through one or more CCs in a UL timing group, and may simultaneously receive UL synchronization information corresponding to the UL timing group through the one or more CCs. The UL timing adjusting unit 1120 may establish a UL synchronization of the UL timing group based on the UL synchronization information received by the transceiving unit 1150.

The UL timing group may be generated by the UE or the eNB for establishing the UL synchronization, and one or more delegate CCs may be selected by the UE or the eNB based on a state of the UL timing group and characteristics of a plurality of CCs forming the UL timing group. When the UL timing group is configured, the conditions d-i) through d-v) and the conditions e-i) through e-iv) may be taken into consideration. When the delegate CC is selected, the conditions f-i) through f-vii) may be taken into consideration.

The transceiving unit 1150 may simultaneously transmit a synchronization request message through all CCs forming a CC set, before the UL group is generated by is the UE or the eNB.

The connection mode determining unit 1105 may determine a connection mode with the eNB. That is, when the connection mode is an UE RRC_IDLE mode or UL synchronization with the eNB is not established, the connection mode determining unit 1105 may enable the UE to change the connection mode to an RRC_CONNECTED mode or enable the UL synchronization to be established.

For example, the connection mode determining unit 1105 may transmit an RRC connection request message to the eNB through use of the transceiving unit 1150, may receive an RRC connection setup message from the eNB, and may complete the RRC connection setup through use of an RRC connection setup complete message.

The transceiving unit 1150 may perform transmission and reception of information with the eNB. For example, the transceiving unit 1150 may receive CC set information and information associated with synchronization from the eNB. After receiving the CC set information, the transceiving unit 1150 may receive SI associated with the CCs in the CC set, from the eNB. The SI information may include frequency band information of a CC, information associated with an available frequency magnitude, and the like.

The CC set determining unit 1140 may determine at least one CC available to the UE, from the CC set information. The CC set may be determined based on a difference in UL synchronization times of the CCs available to the UE, type information of each CC, a center frequency location of each CC, a service type of each CC, a network service for each CC, and the like.

The UL timing group generating unit 1130 may generate a UL timing is group of the UE based on the CC set determined by the CC set determining unit 1140. Here, the UL timing group may be configured by the UE based on the conditions used in step S460 of FIG. 4 and step S560 of FIG. 5. Also, the UL timing group generating unit 1130 may select a delegate CC of the UL timing group. The UE may set the delegate CC by taking into consideration conditions used in step S465 of FIG. 4 and step S565 of FIG. 5.

Also, as shown in FIGS. 6 and 7, the UL timing group generating unit 1130 may receive the UL timing group information generated by eNB through the transceiving unit 1150, and may store the UL timing group information as a UL timing group. The UL timing group generating unit 1130 may transmit an RA preamble to the eNB through all CCs, and may receive the UL timing group information from the eNB. When an RA response is received through a few CCs, a CC through which the RA response is received is set as a delegate CC of a corresponding group.

The UL timing adjusting unit 1120 may determine a TA value received by the transceiving unit 1150, and may apply the TA value to all CCs of the corresponding UL timing group where the delegate CC is included. That is, the TA value may be applied to the corresponding UL timing group for synchronization with the eNB.

Here, TA information for each UL timing group may be in a form of a to table including a TA value corresponding to a group index, may be in a form of a TA value including a predetermined unit error for each timing group, may be in a form of an error having a size of an integer-multiple of a predetermined unit for each timing group, may be in a form of an error specified in detail for each timing group, and may be in a form of an indicator indicating a TA based on a predetermined rule. Therefore, the UL is timing adjusting unit 1120 may obtain synchronization by applying a determined TA to each UL timing group. Also, for example, when the TA information is included in the synchronization information, the TA information may be set equally to all CCs of the UL timing group.

The TA validity determining unit 1110 may determine the validity of a TA through a CR procedure that is simultaneously performed.

In particular, the UL timing adjusting unit 1120 may determine UL grant information and the TA value that is calculated to adjust a UL transmission time for each group corresponding to the UL timing group, through a random access response message that is received in response to the synchronization request message transmitted by the transceiving unit.

The UL timing adjusting unit 1120 may establish a UL synchronization based on the determined UL synchronization. In this example, the UL timing adjusting unit 1120 may establish the UL synchronization based on a TA value distinguished based on the UL timing group, may establish the UL synchronization based on a predetermined unit error distinguished based on the UL timing group, may establish the UL synchronization based on an error that is distinguished based on the UL timing group and has a size of an integer-multiple of a predetermined unit value, and may establish the UL synchronization based on an indicator associated with a rule determined based on the UL timing group. Here, the UL synchronization information may be distinguished based on a group index of the UL timing group.

In FIG. 11, a process of obtaining the synchronization information may be simultaneously performed through CCs. This may be simultaneously performed through is all CCs or delegate CCs of groups.

The transceiving unit 1150 of FIG. 11 may control transmission and reception that is simultaneously performed in a CC. The transceiving unit 1150 may simultaneously transmit a message requesting synchronization (for example, an RA preamble) to the eNB through the delegate CCs or all CCs, and may simultaneously receive information associated with synchronization from the eNB through the delegate CCs or all the CCs. Also, the transceiving unit 1150 may control reception and transmission of a message for RRC reconfiguration and obtaining of synchronization.

1. A method for an evolved Node-B (eNB) to establish an uplink (UL) synchronization in a wireless communication system, the method comprising:
simultaneously receiving a synchronization request message from a user equipment (UE) through component carriers (CCs) forming a CC set;
simultaneously transmitting UL synchronization information to the UE through a few or all of the CCs forming the CC set;
simultaneously receiving the synchronization message from the UE through one or more delegate CCs of a UL timing group; and
simultaneously transmitting UL synchronization information corresponding to the UL timing group to the UE through the one or more delegate CCs,
wherein the delegate CCs are selected by the UE or the eNB, based on a state of the UL timing group and characteristics of a plurality of CCs forming the UL timing group.

2. The method as claimed in claim 1, further comprising:
generating the UL timing group; and
selecting one or more delegate CCs of the UL timing group.

3. The method as claimed in claim 2, further comprising:
transmitting, to the UE, information associated with the UL timing group and information associated with one or more delegate CCs through a physical downlink control channel (PDCCH), a radio resource control (RRC) signaling, a broadcasting channel, or a media access control (MAC) message.

4. The method as claimed in claim 1, wherein the UL timing group is configured of i) at least one CC having a difference in a center frequency value within a threshold range, ii) at least one CC to which a same beamforming scheme is applied, iii) at least one CC used in devices in the same radio network or iv) at least one CC that does not belong to another UL timing group, from among the plurality of CCs.

5. The method as claimed in claim 1, wherein the one or more delegate CCs correspond to at least one of i) a CC having a lowest center frequency value, ii) a CC having a center frequency value that is closest to a mean value, iii) a CC having a highest center frequency value, iv) a CC having a broadest frequency band, and v) a CC set to be used for monitoring quality of a downlink (DL), from among the plurality of CCs forming the UL timing group, and the CC is included in one or more serving cells.

6. The method as claimed in claim 1, further comprising:
setting the CC set to be used by the UE, before simultaneously receiving the synchronization request message through all the CCs; and
transmitting, to the UE, information associated with the set CC set through a primary serving cell or a primary CC.

7. The method as claimed in claim 1, wherein simultaneously receiving of the synchronization request message comprises:
simultaneously receiving a random access preamble signal; and
simultaneously receiving the random access preamble signal from the UE through the one or more delegate CCs.

8. The method as claimed in claim 1, further comprising:
calculating a timing advance (TA) value to adjust a UL transmission time for each group corresponding to the UL timing group in response to the received synchronization request message; and
transmitting the calculated TA value to the UE through UL grant information for the UE and a random access response message.

9. The method as claimed in claim 1, wherein the UL synchronization information is calculated by comparing, with a predetermined threshold, a difference in center frequency values of a plurality of CCs in the CC set that is set to be used for the UE; or
determining whether CCs correspond to CCs having a same beamforming scheme, correspond to CCs updated in response to a synchronization update request, or correspond to CCs that do not provide a service in a macrocell but provide a service in a space superposed by a coverage cell that is smaller than the macrocell, and calculating the UL synchronization information to enable the CCs to have different transmission times.

10. A method for a user equipment (UE) to establish an uplink (UL) synchronization, the method comprising:
simultaneously transmitting a synchronization request message to an evolved Node-B (eNB) through component carriers (CCs) forming a CC set;
simultaneously receiving UL synchronization information from the eNB through a few or all of the CCs forming the CC set;
simultaneously transmitting the synchronization request message to the eNB through one or more delegate CCs of a UL timing group;
simultaneously receiving UL synchronization information corresponding to the UL timing group from the eNB through the one or more delegate CCs; and
establishing synchronization by applying, to the UL timing group, the UL synchronization information corresponding to the UL timing group received through the one or more delegate CCs,
wherein the delegate CCs are selected by the UE or the eNB based on a state of the UL timing group and characteristics of a plurality of CCs forming the UL timing group.

11. The method as claimed in claim 10, further comprising:
generating the UL timing group based on the UL synchronization information received through the CCs forming the CC set; and
selecting one or more delegate CCs of the UL timing group.

12. The method as claimed in claim 10, further comprising:
receiving information associated with the UL timing group and information associated with one or more delegate CCs, generated by the eNB, through a physical downlink control channel (PDCCH), a radio resource control (RRC) signaling, a broadcasting channel, or a media access control (MAC) message.

13. The method as claimed in claim 10, wherein the UL timing group is configured of i) at least one CC having a difference in a center frequency value within a threshold range, ii) at least one CC to which a same beamforming scheme is applied, iii) at least one CC used in devices in the same radio network or iv) at least one CC that does not belong to another UL timing group, from among the plurality of CCs.

14. The method as claimed in claim 10, wherein the one or more delegate CCs correspond to at least one of i) a CC having a lowest center frequency value, ii) a CC having a center frequency value that is closest to a mean value, iii) a CC having a highest center frequency value, iv) a CC having a broadest frequency band, and v) a CC set to be used for monitoring quality of a downlink (DL), from among the plurality of CCs forming the UL timing group, and the CC is included in one or more serving cells.

15. The method as claimed in claim 10, wherein, before transmitting of the synchronization request message, the method further comprises:
receiving information associated with the CC set to be used by the UE from the eNB through a primary service cell or a primary CC.

16. The method as claimed in claim 10, wherein simultaneously transmitting of the synchronization request message comprises:
simultaneously transmitting a random access preamble signal; and
simultaneously transmitting the random access preamble signal to the eNB through the one or more delegate CCs.

17. The method as claimed in claim 10, further comprising:
receiving, from the eNB, a timing advance (TA) value calculated to adjust a UL transmission time for each group corresponding to the UL timing group in response to the transmitted synchronization request message, through UL grant information for the UE and a random access response message.

18. The method as claimed in claim 10, wherein the UL synchronization information includes a TA value distinguished based on the UL timing group, includes a predetermined unit error distinguished based on the UL timing group, or includes the error distinguished based on the UL timing group and having a size of an integer-multiple of a predetermined unit value, or is configured as an indicator associated with a rule determined based on the UL timing group; and
the UL synchronization information is distinguished based on a group index of the UL timing group.

19. An evolved Node-B (eNB) that establishes an uplink (UL) synchronization in a wireless communication system, the eNB comprising:
a UL synchronization establishing unit to generate UL synchronization information corresponding to a UL timing group; and
a transceiving unit to simultaneously receive a synchronization request message from a user equipment (UE) through one or more delegate component carriers (CCs) of the UL timing group, and to simultaneously transmit the UL synchronization information corresponding to the UL timing group to the UE through the one or more delegate CCs,
wherein the delegate CCs are selected by the UE or the eNB based on a state of the UL timing group and characteristics of a plurality of CCs forming the UL timing group; and
before the UL group is generated or when the UL group requires reconfiguration, the transceiving unit simultaneously receives a synchronization request message from the UE through CCs forming a CC set, and simultaneously transmits UL synchronization information to the UE through a few or all of the CCs forming the CC set.

20. The eNB as claimed in claim 19, further comprising:
a UL timing group generating unit to generate the UL timing group and to select one or more delegate CCs of the UL timing group.

21. The eNB as claimed in claim 20, wherein the transceiving unit transmits information associated with the UL timing group and information associated with the one or more delegate CCs to the UE through a physical downlink control channel (PDCCH), a radio resource control (RRC) signaling, a broadcasting channel, or a media access control (MAC) message.

22. The eNB as claimed in claim 19, wherein the UL timing group is configured of i) at least one CC having a difference in a center frequency value within a threshold range, ii) at least one CC to which a same beamforming scheme is applied, iii) at least one CC used in devices in the same radio network or iv) at least one CC that does not belong to another UL timing group, from among the plurality of CCs.

23. The eNB as claimed in claim 19, wherein the one or more delegate CCs correspond to at least one of i) a CC having a lowest center frequency value, ii) a CC having a center frequency value that is closest to a mean value, iii) a CC having a highest center frequency value, iv) a CC having a broadest frequency band, and v) a CC set to be used for monitoring quality of a DL, from among the plurality of CCs forming the UL timing group, and the CC is included in one or more serving cells.

24. The eNB as claimed in claim 19, further comprising:
a CC set determining unit to determine the CC set to be used by the UE,
wherein the transceiving unit transmits information associated with the set CC set through a primary serving cell or a primary CC before receiving the synchronization request message.

25. The eNB as claimed in claim 19, wherein the transceiving unit determines whether the synchronization request message is a random access preamble signal, and simultaneously receives the random access preamble signal through one or more delegate CCs.

26. The eNB as claimed in claim 19, wherein the UL synchronization establishing unit calculates a timing advance (TA) value to adjust a UL transmission time for each group corresponding to the UL timing group in response to the received synchronization request message; and
the transceiving unit transmits the calculated TA value to the UE through UL grant information for the UE and a random access response message.

27. The eNB as claimed in claim 19, wherein the UL synchronization establishing unit calculates the UL synchronization information by comparing, with a predetermined threshold, a difference in center frequency values of a plurality of component carriers (CCs) in the CC set that is configured for the UE, or determines whether CCs correspond to CCs having a same beamforming scheme, correspond to CCs updated in response to a synchronization update request, or correspond to CCs that do not provide a service in a macrocell but provide a service in a space superposed by a coverage cell that is smaller than the macrocell and calculates the UL synchronization information to enable the CCs to have different transmission times.

28. A user equipment (UE) that establishes an uplink (UL) synchronization in a wireless communication system, the UE comprising:
a transceiving unit to simultaneously transmit a synchronization request message through one or more delegate CCs of a UL timing group, and to simultaneously receive UL synchronization information corresponding to the UL timing group from an evolved Node-B (eNB) through the one or more delegate CCs; and
a UL timing adjusting unit to establish synchronization by applying, to the UL timing group, the UL synchronization information corresponding to the UL timing group received through the one or more CCs,
wherein the delegate CCs are selected by the UE or the eNB based on a state of the UL timing group and characteristics of a plurality of CCs forming the UL timing group; and
before the UL group is generated or when the UL group requires reconfiguration, the transceiving unit simultaneously transmits a synchronization request message to the eNB through CCs forming the CC set, and simultaneously receives UL synchronization information from the eNB through a few or all of the CCs forming the CC set.

29. The UE as claimed in claim 28, further comprising:
a UL timing group generating unit to generate the UL timing group based on the UL synchronization information received through the CCs forming the CC set, and to select one or more delegate CCs of the UL timing group.

30. The UE as claimed in claim 28, wherein the transceiving unit receives information associated with the UL timing group and information associated with the one or more delegate CCs, generated by the eNB, through a physical downlink control channel (PDCCH), a radio resource control (RRC) signaling, a broadcasting channel, or a media access control (MAC) message.

31. The UE as claimed in claim 28, wherein the UL timing group is configured of i) at least one CC having a difference in a center frequency value within a threshold range, ii) at least one CC to which a same beamforming scheme is applied, iii) at least one CC used in devices in the same radio network or iv) at least one CC that does not belong to another UL timing group, from among the plurality of CCs.

32. The UE as claimed in claim 28, wherein the one or more delegate CCs correspond to at least one of i) a CC having a lowest center frequency value, ii) a CC having a center frequency value that is closest to a mean value, iii) a CC having a highest center frequency value, iv) a CC having a broadest frequency band, and v) a CC set to be used for monitoring quality of a downlink (DL), from among the plurality of CCs forming the UL timing group, and the CC is included in one or more serving cells.

33. The UE as claimed in claim 28, wherein, before transmitting of the synchronization request message, the transceiving unit receives information associated with the CC set to be used by the UE from the eNB through a primary service cell or a primary CC.

34. The UE as claimed in claim 28, wherein the transceiving unit determines whether the synchronization request message is a random access preamble signal, and simultaneously transmits the random access preamble signal through the one or more delegate CCs.

35. The UE as claimed in claim 28, wherein the UL timing adjusting unit determines the UL grant information and a timing advance (TA) value that is calculated to adjust a UL transmission time for each group corresponding to the UL timing group, based on a random access response message received in response to the synchronization request message transmitted by the transceiving unit.

36. The UE as claimed in claim 28, wherein the UL timing adjusting unit establishes a UL synchronization based on the determined UL synchronization information, through use of a TA value distinguished based on the UL timing group, a predetermined unit error distinguished based on the UL timing group, an error distinguished based on the UL timing group and having a size of an integer-multiple of a predetermined unit value, or an indicator associated with a rule determined based on the UL timing group; and
the UL synchronization information is distinguished based on a group index of the UL timing group.
